(19) United States
(12) Patent Application Publication
(10) Pub. No.: US 2017/0140786 A1
(43) Pub. Date: May 18, 2017

(54) DATA READOUT DEVICE FOR READING OUT DATA FROM A DATA CARRIER

(71) Applicant: BASF SE, Ludgiwshafen (DE)

(72) Inventors: Robert SEND, Karlsruhe (DE); Ingmar BRUDER, Neuleiningen (DE); Stephan IRLE, Siegen (DE); Erwin THIEL, Siegen (DE)

(21) Appl. No.: 15/301,112

(22) PCT Filed: Mar. 26, 2015
(86) PCT No.: PCT/IB2015/052233

§ 371 Date: Sep. 30, 2016

(30) Foreign Application Priority Data
Mar. 31, 2014 (EP) 14162683.8

(51) Int. Cl. G11B 7/13; G11B 7/1362

(52) U.S. Cl. CPC G11B 7/13; G11B 7/1362; G11B 2007/0013

(57) ABSTRACT

A data readout device (114) for reading out data from at least one data carrier (112) having data modules (116) located at least two different depths within the at least one data carrier (112) is disclosed. The data readout device (114) comprises: —at least one illumination source (122) for directing at least one light beam (124) onto the data carrier (112); -at least one detector (130) adapted for detecting at least one modified light beam modified by at least one of the data modules (116), the detector (130) having at least one optical sensor (132), wherein the optical sensor (132)has at least one sensor region (134), wherein the optical sensor (132)is designed to generate at least one sensor signal in a manner dependent on an illumination of the sensor region (134)by the modified light beam, wherein the sensor signal, given the same total power of the illumination,is dependent on a beam cross-section of the modified light beam in the sensor region (134); and -at least one evaluation device (136) adapted for evaluating the at least one sensor signal and for deriving data stored in the at least one data carrier (112) from the sensor signal. Further, a data storage system (110), a method for reading out data from at least one data carrier (112) and a use of an optical sensor (132) for reading out data are disclosed.

### FIELD OF THE INVENTION

The invention relates to a data readout device and a method for reading out data from a data carrier. The invention further relates to a data storage system and to a use of an optical sensor for reading out data. The devices, the method and the use according to the present invention specifically may be employed in the field of data processing and information technology, such as in computing, data transfer or data storage.

### PRIOR ART

In the art of information technology, a plurality of data storage devices and data readout devices are known. Specifically, optical data carriers and corresponding optical readout devices are known, such as compact discs (CDs), digital versatile disks (DVDs), Blu-ray discs or the Archival Disk technology. These data storage devices generally are based on the use of a data carrier layer or information layer disposed on or embedded in a matrix material, such as a disk made of transparent polycarbonate. The information layer typically comprises a thin reflective layer, such as a thin layer of aluminum. Therein, information modules such as local depressions or protrusions are contained, by which a readout light beam is reflected.

The technologies differ with regard to their respective optical readout wavelengths, with regard to the size of their data modules, with regard to their information density and with regard to the position of the information layer. CDs typically make use of a readout wavelength of 780 nm. The readout light beam passes through the matrix material before illuminating the information layer. A spot size of 2.1 μm and a track separation of 1.6 μm are achieved. DVDs typically make use of a readout wavelength of 650 nm, achieving a spot size of 1.3 μm and a track separation of 0.74 μm. The information layer typically is embedded into the matrix material, such that the readout light beam partially passes through the matrix material before illuminating the information layer. Blu-ray technology typically makes use of a readout wavelength of 405 nm, achieving a spot size of 0.6 μm and a track separation of 0.32 μm.

Further, most recently, Sony Corporation and Panasonic Corporation announced the so-called Archival Disk technology which, most likely, will be introduced in 2015. The Archival Disc standard makes use of a disc structure featuring dual sides, with three layers on each side, and a Land and Groove format. A track pitch of 0.225 μm, a data bit length of 79.5 nm, and Reed-Solomon Code error detection will be used.

The information density of information storable within the data carriers is typically limited by the spatial separation of the reflective data modules and by the track separation. As demonstrated by CD, DVD and Blu-ray technology, the information density increases with decreasing wavelength. Still, mainly due to availability of appropriate light sources and detectors as well as due to the limited availability of appropriate manufacturing techniques for suitable information layers, a further increase of information density beyond the blue or ultraviolet wavelength range, within the near future, is unlikely. Further, wavelengths in the ultraviolet range typically tend to induce radiation damages in currently used carrier materials such as appropriate plastic materials. Therefore, despite the significant progress that has been made, there still remains a need for improved optical data storage technologies.

With regard to suitable readout devices, a large number of optical sensors are known. Typically, in optical storage devices such as CDs, DVDs or Blu-ray discs, inorganic photodiodes are used. Further, in other fields of technology, a plurality of additional optical sensors and photovoltaic devices are known. While photovoltaic devices are generally used to convert electromagnetic radiation, for example, ultraviolet, visible or infrared light, into electrical signals or electrical energy, optical detectors are generally used for picking up image information and/or for detecting at least one optical parameter, for example, a brightness.

A large number of optical sensors which can be based generally on the use of inorganic and/or organic sensor materials are known from the prior art. Examples of such sensors are disclosed in US 2007/0176165 A1, U.S. Pat. No. 6,995,445 B2, DE 2501124 A1, DE 3225372 A1 or else in numerous other prior art documents. To an increasing extent, in particular for cost reasons and for reasons of large-area processing, sensors comprising at least one organic sensor material are being used, as described for example in US 2007/0176165 A1. In particular, so-called dye solar cells are increasingly of importance here, which are described generally, for example in WO 2009/013282 A1.

Various types of detectors on the basis of such optical sensors are known. Such detectors can be embodied in diverse ways, depending on the respective purpose of use. Examples of such detectors are imaging devices, for example, cameras and/or microscopes. High-resolution confocal microscopes are known, for example, which can be used in particular in the field of medical technology and biology in order to examine biological samples with high optical resolution. Further examples of detectors for optically detecting at least one object are distance measuring devices based, for example, on propagation time methods of corresponding optical signals, for example laser pulses. Further examples of detectors for optically detecting objects are triangulation systems, by means of which distance measurements can likewise be carried out.

In WO 2012/110924 A1, the content of which is herewith included by reference, a detector for optically detecting at least one object is proposed. The detector comprises at least one optical sensor. The optical sensor has at least one sensor region. The optical sensor is designed to generate at least one sensor signal in a manner dependent on an illumination of the sensor region. The sensor signal, given the same total power of the illumination, is dependent on a geometry of the illumination, in particular on a beam cross section of the illumination on the sensor area. In the following, optical sensors exhibiting this effect of the sensor signal being dependent on the photon density or flux of an illuminating light beam, given the same total power of illumination, such as the devices disclosed by WO 2012/110924 A1, are generally referred to as FiP devices, indicating that the sensor signal or photocurrent i is dependent on the photon flux F, given the same total power P of illumination. The detector as disclosed by WO 2012/110924 A1 furthermore has at least one evaluation device. The evaluation device is designed to generate at least one item of geometrical information from the sensor signal, in particular at least one item of geometrical information about the illumination and/or the object. WO 2014/097181, the full content of all of which is herewith included by reference, discloses a method and a detector for determining a position of at least one object, by using at least one transversal optical sensor and at least one longitudinal optical sensor. Again, specifically for the longitudinal optical sensor, one or more FiP sensors may be used, which may preferably be arranged as a sensor stack. Further, specifically, the use of sensor stacks is disclosed, in order to determine a longitudinal position of the object with a high degree of accuracy and without ambiguity.

Despite the advantages implied by the above-mentioned detectors and the optical sensors, there still remains a need for improved data storage technologies. Thus, specifically, the information density may further be increased. Further, there still remains a need for simplified readout devices.

### Problem Addressed by the Invention

It is therefore an object of the present invention to provide devices and methods which solve the above-mentioned technical challenges. Specifically, a data readout device, a data storage system and a method for reading out data from a data carrier shall be disclosed which provide an increased information density, by still using simple and cost efficient readout technology.

### SUMMARY OF THE INVENTION

This problem is solved by the invention with the features of the independent claims. Advantageous developments of the invention, which can be realized individually or in combination, are presented in the dependent claims and/or in the following specification and detailed embodiments.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may refer to a situation in which, besides B, no other element is present in A (i.e. a situation in which A solely and exclusively consists of B) and to a situation in which, besides B, one or more further elements are present in entity A, such as element C, elements C and D or even further elements.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restriction regarding the scope of the invention and without any restriction regarding the possibility of combining the features introduced in such a way with other optional or non-optional features of the invention.

In a first aspect of the present invention, a data readout device is disclosed. As used herein, a “data readout device” generally refers to a device adapted for reading out data from at least one data carrier, i.e. the single data carrier or the at least two separate data carriers. As further used herein, a “data carrier” generally refers to a device adapted for storing readable information therein, preferably digital information, which may be read out by an appropriate data readout device. Specifically, the data carrier may be an optical data carrier adapted for optically reading out information contained therein. Therein, an optical readout generally refers to a readout method in which optical techniques are used, such as by illuminating the data carrier with light, such as at least one light beam, and detecting one or more of: a reaction of the data carrier to the illumination, such as a phosphorescence and/or a fluorescence; a modification of the light beam, such as a wavelength change; a reflection of the light beam by the data carrier; a transmission of the light beam by the data carrier; a scattering of the light beam by the data carrier.

Specifically, in the present invention, the data carrier is a data carrier having data modules located at at least two different depths within the at least one data carrier, wherein the term “within” may refer to a single data carrier or to at least two separate data carriers. Herein, the single data carrier or the at least two separate data carriers may, preferably, be arranged within a stack of data carriers, also denoted as “data carrier stack”. In particular, the data carriers within the data carrier stack may be arranged in a manner that the at least one light beam directed onto the data carrier stack may be able to traverse all of the data carriers within the data carrier stack. Consequently, the different data modules may be located at at least two different depths within the same data carrier and/or located at at least one depth within at least two different data carriers. By way of example, two out of four exemplary data modules may each be located at two different depths within two separate data carriers which, due to their spatial extent, are located at two different longitudinal positions, i.e. depths. Other arrangements are feasible. Herein, the at least two data carriers may be two identical data carriers or two different data carriers which differ with respect to each other in regard of at least one optical property, in particular, one or more of: a reaction of the data carrier to the illumination, such as a phosphorescence and/or a fluorescence; a modification of the light beam, such as a wavelength change; a reflection of the light beam by the data carrier; a transmission of the light beam by the data carrier; a scattering of the light beam by the data carrier.

As used herein, a “data module” generally refers to an entity of the data carrier having the smallest possible information content. Thus, as an example, the data module may represent a bit which may be adapted to assume a state of 0 or 1. Other embodiments are feasible. The data modules specifically may be embodied to assume at least two different states, which may be different mechanical or physical configurations which may be adjusted once or more than once when writing information into the data carrier. Thus, as an example, each data module may assume two different states. As will be outlined in further detail below, the data module specifically may be embodied as one or both of local depressions or protrusions within an information layer.

Herein, the data modules may, preferably, be or comprise reflective data modules. As used herein, the term “reflective” generally refers to the fact that the data modules are adapted to fully or partially change a local transmission of a light beam by one or more of reflection, scattering or deflection. Thus, the reflective data modules may be adapted to be reflective by themselves, providing fully or partially reflective surfaces, or may be adapted to provide transmissive portions within a reflective surrounding of the respective modules.

Alternatively or in addition, the data modules may, preferably, be or comprise data modules which are capable of modifying a transmission of an incident light beam, irrespective of a fact whether they might exhibit reflective properties or not. As an example, the data modules may appear as an arrangement of small areas, such as small colored areas, in particular small black areas, also denominated as black points, which may be located within the information layer and which may be capable of disturbing the incident light beam in a manner that the transmission of the incident light beam may be modified, generally be diminished, by the respective data modules. In this particular embodiment, a transfer device may be employed in order to focus the light beam onto one of the depths in which the data modules are located. Similar to an observation of objects in a light microscope, such a focusing of the incident light beam may, thus, allow the small areas as comprised within the information layer of the data carrier to modify the incident light beam.

Further, when referring to a “depth” within the at least one data carrier, reference is made to a distance between at least one reference plane perpendicular to an incident light beam, such as a reference surface of the particular data carrier, and the respective module. Thus, as an example, the particular data carrier may provide at least one flat surface, such as at least one flat entry surface through which one or more light beams may enter the data carrier. The depth of a data module generally may refer to the distance between this flat entry surface of the particular data carrier and the respective data module, which may range from zero to the full thickness of the particular data carrier. Specifically, data modules may be arranged in two or more predetermined depth levels within the same data carrier or within separate data carriers, which, as described above and/or below, may, preferably, be arranged within the data carrier stack. In the latter case, in particular, when the space between the respective data carriers within a single data carrier stack may be filled with a film of an optically transparent adhesive, the single data carrier stack may be treated as a unit and the respective depth of the location of the data carriers may, for example, be determined from the surface of a first data carrier within the data carrier stack and the respective module, wherein the “first data carrier” may refer to the data carrier being first impinged in an event in which a light beam impinges on the data carrier stack. However, any other plane which comprises a perpendicular orientation with respect to the incident light beam may be also employed as the reference plane for the depth.

The data readout device comprises at least one illumination source for directing at least one light beam onto the at least one data carrier, i.e. the single data carrier or the at least two separate data carriers. As used herein, an “illumination source” generally refers to a device adapted for generating light, preferably for generating one or more light beams. Therein, “light” generally refers to electromagnetic radiation in one or more of the visible spectral range, the infrared spectral range or the ultraviolet spectral range. Therein, the visible spectral range generally refers to a wavelength range of 380 nm to 780 nm, the infrared spectral range generally refers to a wavelength range of 780 nm to 1 mm, more preferably to a wavelength range of 780 nm to 3.0 μm, and the ultraviolet spectral range refers to a wavelength range of 1 nm to 380 nm, more preferably to a wavelength range of 200 nm to 380 nm. Specifically, visible light may be used.

As further used herein, a “light beam” generally refers to a portion of light traveling into a predetermined direction. The light beam specifically may be a collimated light beam. Further, the light beam specifically may be a coherent light beam. The illumination source consequently may comprise an arbitrary light source adapted for generating one or more light beams. As an example, the illumination source may comprise at least one laser, such as one or more of a semiconductor laser, a solid state laser, a dye laser or a gas laser. As an example, one or more laser diodes may be used. Additionally or alternatively, the illumination source may comprise other types of light sources such as one or more of a light emitting diode (LED), a light bulb or a discharge lamp. Further, the illumination source may comprise one or more beam transfer devices, such as one or more beam shaping elements like one or more lenses or lens systems, such as for collimating and/or focusing the at least one light beam. The illumination source may be adapted for generating a single light beam or a plurality of light beams. The illumination source may be adapted for generating a light beam having a single color or a plurality of light beams having the same color or having different colors.

The data readout device further comprises at least one detector adapted for detecting at least one modified light beam modified by at least one of the data modules, in particular at least one reflected light beam reflected by at least one of the reflective data modules and/or at least one transmitted light beam modified by at least one of the data modules being capable for this purpose. As used herein, a “detector” generally is a device adapted for one or more of recording, registering or monitoring one or more parameters, such as optical parameters, such as at an intensity of light. The detector generally may be adapted for generating one or more detector readout signals or readout information, such as in an electronic format which may be an analogue and/or a digital format.

The detector comprises at least one optical sensor. As used herein, an “optical sensor” generally refers to a device adapted for performing at least one optical measurement. The optical sensor has at least one sensor region, wherein the optical sensor is designed to generate at least one sensor signal in a manner dependent on an illumination of the sensor region by the modified light beam, in particular by the reflected light beam and/or the transmitted light beam, wherein the sensor signal, given the same total power of the illumination, is dependent on a beam cross-section of the modified light beam, in particular of the reflected light beam and/or of the transmitted light beam, in the sensor region. Thus, generally, the at least one optical sensor is or comprises at least one FiP sensor as disclosed in the prior art section above. For potential specific definitions, details or optional layer setups of the at least one optical sensor, reference may be made to one or more of the above-mentioned documents WO 2012/110924 A1 or WO 2014/097181, the full content of all of which is herewith included by reference. Specifically, for potential embodiments of the optical sensor, reference may be made to the embodiments of optical sensors disclosed in WO 2012/110924 A1 or the embodiments of the longitudinal optical sensors disclosed in WO 2014/097181. It shall be noted, however, that other embodiments are feasible, as long as the above-mentioned FiP effect occurs. Further optional details of the optical sensor will be disclosed below.

As used herein, the term “sensor signal” generally refers to an arbitrary signal generated by the at least one optical sensor. The sensor signal, as an example, may be an electrical signal, such as a current and/or a voltage. As will be explained in further detail below, the optical sensor preferably comprises one or more dye-sensitized solar cells (DSCs), more preferably one or more solid dye-sensitized solar cells (sDSCs). However, other kinds of optical sensors, in particular optical sensors comprising an inorganic sensor material, may also be applicable. In these devices, generally, the sensor signal specifically may be an electrical current such as a photocurrent and/or a secondary sensor signal derived thereof. The sensor signal may be a single sensor signal or may comprise a plurality of sensor signals, such as by providing a continuous sensor signal. Further, the sensor signal may be or may comprise one or both of an analogue signal or a digital signal. The optical sensor may further provide one or more primary sensor signals which, optionally, may be transformed into one or more secondary sensor signals, by using appropriate signal processing. In the following and in the context of the present invention, both the primary sensor signal and the secondary sensor signal will be referred to as the “sensor signal”, non-withstanding the fact that both options still exist. A data processing or preprocessing, as an example, may comprise a filtering and/or an averaging.

The data readout device further comprises at least one evaluation device adapted for evaluating the at least one sensor signal and for deriving data stored in the data carrier from the sensor signal. As used herein, the term “evaluation device” generally refers to an arbitrary device adapted to perform the named operations, preferably by using at least one data processing device and, more preferably, by using at least one processor. Thus, as an example, the at least one evaluation device may comprise at least one data processing device having a software code stored thereon comprising a number of computer commands. Additionally or alternatively, the evaluation device may comprise one or more of a measurement device or a signal processing device, such as for one or more of measuring, recording, preprocessing of processing the at least one sensor signal. Further, the at least one evaluation device may comprise one or more decoding devices for decoding data contained in the at least one sensor signal and/or for transforming the at least one sensor signal into a computer readable data such as binary or digital data. For the latter purpose, one or more decoding devices may be present which, in a sensor signal, may distinguish between a first signal state indicating a first value, such as 0, and at least one second signal state indicating a second value, such as 1. This type of decoding optical data is generally known from optical data storage technology such as CDs, DVDs or Blu-ray discs.

The evaluation device specifically may be adapted to determine the depth of the data module within the respective data carrier from which the modified light beam, in particular the reflected light beam and/or the transmitted light beam, originates, i.e. by which the light beam is modified, in particular reflected and/or transmitted, by evaluating the at least one sensor signal. For this purpose, evaluation device, as an example, may comprise a lookup table which, for various signal levels or even for each signal level, may indicate a) a value of the respective data module, such as value 0 or value 1, and b) a depth of the respective data module by which the light beam inducing the sensor signal is modified. Again, for this purpose, the above-mentioned FiP effect may be used. Thus, for each optical sensor and for a known total intensity and/or total power P of the light beam, a so-called FiP curve may be generated, indicating a correlation between a photocurrent i and a beam width w or beam cross-section 2w of a light spot of the modified light beam illuminating the sensor region of the optical sensor. Since, in the known setup, the propagation parameters of the light beam generally are known or may be determined, a correlation between the depth of the data module by which the light beam is modified and the beam width w or beam cross-section 2w may be generated empirically, semi-empirically or analytically, or even a direct correlation between the sensor signal and the depth of the modified data module by which the beam is modified. This is generally due to the fact that, for a widening light beam, the beam cross-section increases with increasing depth of the data module and/or with increasing optical distance passed by the light beam. Similarly, for a narrowing light beam, the beam cross-section generally decreases with increasing depth of the data module and/or with increasing optical distance passed by the light beam. Thus, a correlation between the depth of the data module and the depth of the data module may be generated and may be used for evaluating the at least one sensor signal. Examples between a correlation of a sensor signal and a measurement of a distance for typical FiP sensors are given in WO 2012/110924 A1 and WO 2014/097181 and may also be used in the context of the present invention for evaluating the at least one sensor signal and for deriving information regarding the depth of the data module by which the light beam is modified. Further, as will be outlined in detail below, potential ambiguities in the correlation, such as ambiguities occurring at a distance before and after a focal point of the modified light beam, may be resolved by using a sensor stack of optical sensors, such as described in WO 2014/097181.

Within this regard, it may be advantageous to provide one or more further transfer devices as described elsewhere in this application which are capable of focusing the modified light beam, i.e. the reflected light beam and/or the transmitted light beam, whichever may be applicable, onto the at least one of the optical sensors. As a result, the small areas within at least one of the information layers in the data carriers may be sharply visible by a particular optical sensor which may be placed accordingly within the optical detector.

The evaluation device, as outlined above, may be adapted to determine a beam cross-section of the modified light beam, i.e. the reflected light beam and/or the transmitted light beam, in the sensor region by evaluating the sensor signal and by taking into account known beam properties of the light beam, thereby deriving the depth of the data module from which the modified light beam originates. Additionally or alternatively, a more general correlation between the sensor signal and the depth of the data module may be used, such as the above-mentioned correlation. The evaluation device may be adapted to perform an evaluation algorithm and/or may be adapted to use the above-mentioned correlation, such as by providing a lookup table implementing that correlation, in order to derive the depth of the data modules. Thereby, specifically, the data readout device and, more specifically, the evaluation device, may be adapted to perform a mapping, in order to detect the data modules, including their respective values and their depths. The mapping, as an example, may take place at least partially sequentially and/or may take place for all of the data modules or for a part of the data modules of the data carrier.

Thus, as outlined above, the evaluation device specifically may be adapted to use at least one known correlation between the at least one sensor signal and the depth of the data module within the respective data carrier from which the modified light beam originates. As outlined above, as an example, the correlation may be stored in a data storage of the evaluation device and/or may be provided and/or stored as a lookup table.

As outlined above, the data readout device and/or the evaluation device specifically may be adapted for mapping the data modules. The evaluation device specifically may be adapted to classify sensor signals provided by the optical sensor according to the respective depths of the data modules within the respective data carrier. As used herein, the term “classifying” generally refers to the process of assigning objects to two or more classes. Thus, for each data module recognized, the evaluation device may be adapted to derive, from the sensor signal, a depth of the data module within the respective data carrier and to assign the data module to the respective depth class. Therein, two, three or more depth classes may be used. Thus, a three-dimensional mapping of the at least one data carrier by the data readout device may take place, wherein, for each data module recognized by a modification, in particular by a reflection and/or a transmission, of the light beam, an information value stored in the respective data module is recognized and, additionally, a depth of the respective data module within the respective data carrier is recognized. By using data modules in a three-dimensional arrangement, the depth of the data module may provide additional items of information.

As outlined above, the at least one optical sensor may be or may comprise at least one FiP sensor. For potential embodiments of these sensors, reference may be made to one or more of the prior art documents listed above. Specifically, the at least one optical sensor may be or may comprise an organic photodetector, preferably an organic solar cell, more preferably a dye-sensitized organic solar cell and most preferably a solid dye-sensitized organic solar cell. The at least one optical sensor specifically may be or may comprise at least one photosensitive layer setup, the photosensitive layer setup having at least one first electrode, at least one second electrode and at least one photovoltaic material sandwiched in between the first electrode and the second electrode, wherein the photovoltaic material comprises at least one organic material. The photosensitive layer setup specifically may comprise, preferably in the given order, an n-semiconducting metal oxide, preferably a nanoporous n-semiconducting metal oxide, wherein the photosensitive layer setup further comprises at least one solid p-semiconducting organic material deposited on top of the n-semiconducting metal oxide. The n-semiconducting metal oxide specifically may be sensitized by using at least one dye. For potential embodiments of these materials, reference may be made to the above-mentioned prior art documents or to one or more of the embodiments given in further detail below. Alternatively or in addition, as already mentioned above, other kinds of optical sensors, in particular optical sensors which may comprise an inorganic sensor material, may also be applicable. At least one of the first electrode or the second electrode may fully or partially be transparent. The at least one optical sensor may be or may comprise an opaque optical sensor and/or may be or may comprise at least one transparent or at least partially transparent optical sensor. In the latter case, preferably, both the first electrode and the second electrode may be at least partially transparent.

The at least one optical sensor specifically may be a large area optical sensor, without pixelation or subdivision of the optical sensor into pixels. Thus, the sensor region, as an example, may be a continuous sensor region providing a uniform sensor signal. The sensor region specifically may have a surface area of at least 1 mm², preferably of at least 5 mm², more preferably of at least 10 mm².

The detector, as outlined above, may optionally further comprise at least one transfer device adapted for transferring the modified light beam to the at least one optical sensor. The transfer device preferably may be positioned in a light path in between the illumination source and the at least one data carrier and/or in a light path in between the at least one data carrier and the at least one optical sensor, wherein the at least one data carrier may comprise a single data carrier or at least two separate data carriers. As used herein, a “transfer device” generally is an arbitrary optical element adapted to guide the light beam onto the optical sensor. The guiding may take place with unmodified properties of the light beam or may take place with imaging or modifying properties. Thus, generally, the transfer device might have imaging properties and/or beam-shaping properties, i.e. might change a beam waist and/or a widening angle of the light beam and/or a shape of the cross-section of the light beam when the light beam passes the transfer device. The transfer device, as an example, may comprise one or more elements selected from the group consisting of a lens and a mirror. The mirror may be selected from the group consisting of a planar mirror, a convex mirror and a concave mirror. Additionally or alternatively, one or more prisms may be comprised. Additionally or alternatively, one or more wavelength-selective elements may be comprised, such as one or more filters, specifically color filters, and/or one or more dichroitic mirrors. Again, additionally or alternatively, the transfer device may comprise one or more diaphragms, such as one or more pinhole diaphragms and/or iris diaphragms.

The transfer device can for example comprise one or a plurality of mirrors and/or beam splitters and/or beam deflecting elements in order to influence a direction of the light beam or the modified light beam. Alternatively or additionally, the transfer device can comprise one or a plurality of imaging elements which can have the effect of a converging lens and/or a diverging lens. By way of example, the optional transfer device can have one or a plurality of lenses or lens systems and/or one or a plurality of convex and/or concave mirrors. Once again alternatively or additionally, the transfer device can have at least one wavelength-selective element, for example at least one optical filter. Once again alternatively or additionally, the transfer device can be designed to impress a predefined beam profile on the electromagnetic radiation, for example, at the location of the sensor region and in particular the sensor area. The above-mentioned optional embodiments of the optional transfer device can, in principle, be realized individually or in any desired combination. The at least one transfer device, as an example, may be positioned in front of the detector, i.e. on a side of the detector facing towards the object. Additionally or alternatively, the transfer device may fully or partially be integrated into the illumination source.

The data readout device and the detector may comprise one, two, three or more than three optical sensors. Specifically, as outlined above, the data readout device may comprise a sensor stack of at least two optical sensors. The sensor stack may be arranged such that photosensitive areas of the sensor regions are oriented in a parallel fashion and, as an example, are oriented perpendicular to an optical axis of the detector. Specifically, the sensor stack may comprise a plurality of large area optical sensors, i.e. optical sensors having a single sensor region only. The optical sensors of the sensor stack may be identical or may differ with regard to one or more parameters. Thus, the optical sensors may specifically have one and the same spectral sensitivity or may have differing spectral sensitivities. For potential embodiments of the sensor stack which may be used in the context of the present invention, reference may be made to one or more of WO 2012/110924 A1 and WO 2014/097181.

Generally, and specifically in case a sensor stack is used, preferably, one or more of the optical sensors may be fully or partially transparent. Thus, the optical sensors may provide sufficient transparency for a light beam to fully or partially penetrate one optical sensor in order to reach one or more subsequent optical sensors. Thus, as an example, all optical sensors may fully or partially be transparent, except for the last optical sensor of the sensor stack, which may be transparent or intransparent. As outlined above, for generating a transparent optical sensor, a layer setup may be used having a transparent first electrode and a transparent second electrode.

In case the sensor stack is used, the sensor signals of the optical sensors may be used for various purposes. Again, as an example for the purposes the sensor stack may be used for, reference may be made to WO 2014/097181. However, other purposes are feasible. Generally, the evaluation device may be adapted to evaluate at least the sensor signals generated by at least two of the optical sensors of the sensor stack. Specifically, the evaluation device may be adapted to derive at least one beam parameter from the at least two sensor signals generated by the at least two optical sensors of the sensor stack. Thus, a “beam parameter” as used herein generally refers to an arbitrary parameter or combination of parameters characterizing the light beam, the transmitted light beam, or the reflected light beam. As an example, at least one Gaussian beam parameter may be used, such as the minimum beam waist w₀ and/or the Raleigh length z. Other beam parameters are feasible. By using the sensor stack and by evaluating the sensor signals of the sensor stack, as an example, the above-mentioned ambiguity may be resolved which resides in the fact that a beam waist and equal distances before and after a focal point are identical. By measuring the beam waists at more than one position along an axis of propagation of the light beam, the ambiguity may be resolved, such as by comparing the beam waists. A widening beam waist indicates that the measurements were taken after the focal point, whereas a narrowing beam waist indicates that the measurements were taken before the focal point.

As outlined above, the illumination source preferably is adapted to produce a coherent light beam. Thus, the illumination source preferably may contain one or more coherent light sources. Thus, as an example, one or more lasers may be used, such as semiconductor lasers. Consequently, the illumination source may comprise at least one laser.

The illumination source may be adapted to generate one light beam or several light beams. In case several light beams are produced, the several light beams may have identical or differing spectral properties. As an example, the illumination source may be adapted to generate at least two different light beams having different colors. The detector may be adapted for distinguishing modified light beams having different colors. Thus, as an example, for detection and distinguishing of light beams having different colors, color filters or other wavelength sensitive elements may be used. Additionally or alternatively, as outlined above, different types of optical sensors may be used. By comparing sensor signals generated by optical sensors having differing spectral sensitivities, color information may be retrieved from the sensor signals. Thus, generally, the detector may comprise at least two optical sensors having differing spectral sensitivities. The differing spectral sensitivities, as an example, may be generated by using different types of dyes. Thus, as an example, a first type of optical sensors may be used having a first dye with a first absorption spectrum, and at least one second type of optical sensors may be used, having a second dye with a second absorption spectrum differing from the first absorption spectrum. By comparing the sensor signals of these two types of sensors, color information may be generated. Again, reference may be made to WO 2014/097181 for potential embodiments.

The data readout device according to the present invention provides a plurality of advantages over known data readout devices. Thus, generally, as compared to known optical data storage devices and data storage systems, an increased information density may be achieved, since a three-dimensional data storage is feasible. Thus, a third dimension of data modules may be used, and/or the depth information of the data modules may be used as an additional item of information. Further, several information layers may be used, and the data readout device may be adapted for reading out data from different information layers, preferably simultaneously. The readout of data from the different information layers may take place without refocusing of the light beam. Further, several information layers which may be located within different data carriers may be used, and the data readout device may be adapted for reading out data from the different information layers located within different data carriers, preferably simultaneously. The readout of data from the different information layers may, again, take place without refocusing of the light beam for the different data carriers.

Thus, generally, the data readout device may be adapted to read out information from different depths within the same data carrier or within different data carriers simultaneously, preferably without refocusing the light beam and/or with one single light beam for two or more depths within the same data carrier or within different data carriers. Specifically, the above-mentioned FiP effect allows for reading out several layers at a time whether located within the same data carrier or within different data carriers, preferably without refocusing the beams. Further, using one or more FiP sensors, complex reflections of semitransparent media may be analyzed. In the case of an optical storage medium, these reflections are even well defined.

The at least one data carrier, which may also be referred to as an optical storage medium, may be illuminated by preferably using at least one coherent light source. The light beam may be partially reflected in several information layers of the storage medium. Each information layer may have data modules which may be located at two or more distinct distances, such as distances corresponding to the value 0 or the value 1, within a particular data carrier in order to encode digital information.

The modified light beam, i.e. the reflected light beam and/or the transmitted light beam, may be focused by using the at least one transfer device, such as by using one or more lenses. Thus, the modified light beam may be focused by at least one lens. Further, the modified light beam may be measured by using the at least one optical sensor, specifically the at least one FiP sensor.

Each reflection may lead to a different focal point, such as depending on the depth of the reflective data modules leading to the respective reflection. Similarly, each small area within the data carrier being capable of influencing the transmission of an incident light beam may lead to a different focal point, such as depending on the depth of the data modules leading to the respective modification of the transmission. By using the at least one optical sensor, the position of the data module inducing the respective sensor signal may be determined, specifically a longitudinal position or depth of the data module within the particular data carrier. Specifically in case a sensor stack of optical sensors is used, the sensor stack may be adapted to measure the position of several focal points or depths of information modules simultaneously. Especially in case a stack of data carriers is used, the sensor stack may be adapted to measure the position of several focal points or depths of information modules within one or more data carriers simultaneously. Thus, using FiP sensors for reading out information, specifically for reading out three-dimensional optical storage media, a simple and still robust readout process may be provided which avoids refocusing the light beam, specifically the laser beam, when changing the information layer and which, further, allows for reading out two or more than two information layers simultaneously. Thus, generally, by using the data readout device according to the present invention, a higher amount of data can be processed in less time, as compared to conventional storage systems, and, thus, the information readout rate may be increased.

In a further aspect of the present invention, a data storage system is disclosed. As used herein, a “data storage system” generally refers to a system comprising one or more components, adapted for storing and/or retrieving information, preferably digital information. In case the data storage system comprises several components, the components may be embodied in one single unit or may be embodied as/or handled as separate entities. The data may be stored once by using an appropriate writing process and may be read out once or more than once.

The data storage system comprises at least one data readout device according to the first aspect of the invention, such as according to one or more of the embodiments disclosed above or as disclosed in further detail below. The data storage system further comprises at least one data carrier. As used herein, a “data carrier” generally refers to an element adapted for storing information therein. The data carrier preferably may be handled as a separate entity, independent from the readout device. As will be outlined in further detail below, the data carrier preferably has a disk shape, such as the shape of a circular disk, such as a disk having a thickness of 0.5-5 mm, such as 1-2 millimeters, e.g. 1.2 millimeters, and a diameter of several millimeters, such as a diameter of 50 mm to 20 mm, such as 80 mm or 120 mm. Other shapes and/or dimensions are feasible, such as a cubic shape or a cylindrical shape having a higher thickness as compared to the above-mentioned exemplary thicknesses.

The data carrier may be installed in the data storage system permanently or may be removably inserted into the data storage system, such as into an appropriate data carrier receptacle.

The data carrier has a plurality of data modules, reflective data modules and/or data modules configured for influencing the transmission of an incident light beam which are located at at least two different depths within the data carrier. For further details and definitions, reference may be made to the disclosure of the data readout device given above.

The data carrier may comprise at least one data carrier matrix material. As used herein, a “matrix material” generally refers to a material adapted for providing mechanical stability to the data carrier. Thus, the matrix material may be a rigid or flexible matrix material which contains its shape at least widely during regular handling of the data carrier. Specifically, the matrix material may be or may comprise at least one plastic material, such as a thermoplastic material. As an example, the matrix material may be selected from the group consisting of: a polycarbonate; a polystyrene; a polyester; polyethylene terephthalate (PET); polyamide; poly(methyl-methacrylate) (PMMA). Other materials or combinations of materials are feasible.

In case the data carrier comprises at least one data carrier matrix material, the data modules may be one of: contained in a layer of an at least partially reflective material coated onto the matrix material, contained in a layer of an at least partially absorptive material coated onto the matrix material, or embedded within the matrix material. As an example, the data carrier may comprise a layer setup, the layer setup having at least two different information layers, wherein the data modules are located in the at least two different information layers. As used herein, an “information layer” refers to a layer containing the data modules and, thus, carrying at least part of the information comprised in the data carrier. As an example and as will be outlined in further detail below, the information layer may contain the data modules in a rectangular or circular matrix arrangement. The data modules may be or may define distinct portions of the information layer, wherein each portion may assume at least two different states which may be optically distinguishable. As an example, as outlined above, each portion may assume two or more different heights, indicating, as an example, an information value 0 or an information value 1, depending on the height of the module. The different heights, as an example, may be produced by embossing or engraving, such as by using a mechanical embossing tool and/or an optical engraving by using a laser. By using focused laser beams having different focal depths, information modules may be encoded into the different information layers. Additionally or alternatively, the layer setup may be produced subsequently, by depositing the layers on top of each other, with the information encoded therein.

The information layers specifically may be planar layers. Still, curved embodiments or other non-planar embodiments may be feasible. The information layers generally may be made of any suitable material adapted for providing reflections and/or absorption. Specifically, the information layers fully or partially may be made of at least one at least partially reflective and/or absorptive material, such as one or more metal layers, such as one or more metal layers deposited on top of a substrate which may be a separate substrate or which may be fully or partially identical with the matrix material. Thus, a sandwich setup may be produced, wherein one or more layers of the matrix material are embedded within information layers and/or wherein one or more information layers are embedded within two or more layers of matrix material. Thus, as an example, a layer setup may be used in which a layer of matrix material is sandwiched in between two information layers. Alternatively, an information layer may be sandwiched in between two layers of matrix material, wherein, optionally, one or more information layers are deposited on an outer side of one of the layers of matrix material and/or are sandwiched in between one of the layers of matrix material and an additional layer of matrix material. Various layer setups are possible.

As outlined above, the data modules generally may be portions of the information layer which may assume at least two different states which may be optically distinguishable. Specifically, the data modules may contain one or more of: local deformations in the information layers, local perforations in the information layers, local changes of a reflection and/or absorption of the information layers, local changes of an index of refraction of the information layers. Specifically, in this embodiment or other embodiments of the present invention, the data modules may be partially transparent, such that a part of the incident light of the light beam is transmitted by the data modules and a part of the incident light beam is reflected by the data modules.

The data modules generally may be arranged in an arbitrary arrangement within the data carrier. Specifically, the data modules may be arranged in tracks, as known from CD, DVD or Blu-ray technology. Therein, however, tracks in two or more depths within the data carrier may be present. The tracks generally may have an arbitrary shape. Still, circular tracks or concentric tracks or spiral tracks are preferred, for reasons of simple legibility.

The data modules may further be arranged in a three-dimensional arrangement. Thus, as an example, the three-dimensional arrangement may be or may comprise a circular matrix arrangement or a rectangular matrix arrangement. The three-dimensional arrangement specifically may contain a stack of information layers, such as a stack of at least two or at least three information layers. More generally, the three-dimensional arrangement may contain at least three information layers.

Herein, different data modules may be located within one data carrier or within more than one separate data carriers, such as in one or more data carriers being arranged as a stack of data carriers, also denominated as a “data carrier stack”. As described above and/or below, the different data modules may, thus, be located at at least two different depths within the same data carrier and/or located at at least one depth within at least two different data carriers. Again, as described above, the at least two data carriers may be identical data carriers or data carriers being different with respect to at least one optical property.

The data carriers as used for the present invention may be produced as known from the state of the art. Accordingly, the data carrier, such as the CD, the DVD or the Blu-Ray disc, may, first, be formed from one or more of the matrix materials as described above, such as by pressing a respective amount of the matrix material and, subsequently, be treated in order to generate the data modules within the information layer, in particular by modifying the matrix material at the appropriate locations, preferably by selectively applying a heat treatment, such as by burning the matrix material, for example by using a laser.

For providing a stack of data carriers, two or more of the mentioned data carriers may be arranged in a stacked manner, in particular in which the respective disc-shaped data carriers are placed on top of one another perpendicular with respect to the optical axis of each disc. Particularly in order to provide an optimized optical path for a light beam which traverses the data carrier stack, preferably, a thin film of an optically transparent adhesive may be applied between two of each of the respective discs within the data carrier stack. Herein, the adhesive may, preferably, exhibit a refraction index which may be equal or similar to the refraction index of the matrix material in the data carriers which are located adjacent with respect to the thin adhesive film. As a result, by carefully selecting the corresponding refraction indices an incident beam may be capable of traversing the data carrier stack with only a negligible refraction.

Further, the data carriers may be produced by applying a matrix material onto a suitable substrate, which may comprise a preferably transparent substrate material as selected from the group consisting of: a polycarbonate; poly(methyl-methacrylate) (PMMA); an optical adhesive, such as Evonik Acrifix® 1R 0192, an acrylic resin dissoveld in methacrylic acid methyl ester being polymerized with light. In contrast to the matrix material which requires being soft enough in order to allow receiving a modifying treatment for generating the data modules within the information layer, the substrate which is not designated to receive this kind of treatment may comparatively be stable. Consequently, the substrate may exhibit a thickness which can considerably be lower than the thickness of the matrix material and still offer a comparative stability. Thus, the thickness of a data carrier placed on a substrate including the corresponding substrate may considerably be lower than the thickness of a stand-alone data carrier produced without substrate. By using data carriers which are each placed on a substrate, the thickness of the data carrier stack may, therefore, be reduced without reducing the stability of the data carrier stack. As a further result, the focal depths of the different information layers within the data carrier stack may thus be modified, too, particularly in a manner that the different information layers in the data carrier stack may be located closer to each other compared to using data carriers without substrate. This modification may, in particular, be advantageous for the present invention since it may support avoiding a refocusing of the incident light beam when moving from one information layer to the other, thus, facilitating a reading out of two or more of the two information layers, which are located sufficiently close to each other, simultaneously. Alternatively or in addition, the same optical device may, thus, be capable of reading out more information layers closely located with respect to each other in the data carriers comprising a substrate.

Furthermore, the matrix material as comprised by the transparent data carrier in the data carrier stack may differ for at least two of the data carriers, in particular for all of the data carriers, within the data carrier stack. This distinction may be achieved by providing a matrix material which may differ for each of the data carriers by at least one, preferably one, property of the matrix material. As a preferred example, the data carriers, such as the transparent CDs or DVDs, may comprise a different organic fluorescent dye which may be employed for dying the respective matrix material. As a result, the different colors of the colored data carriers may, for example, be used as a kind of differentiation between the different data carriers.

The data storage system, besides the at least one data readout device and the at least one data carrier, may contain one or more additional components. Thus, as an example, the data storage system may further comprise at least one actuator for inducing a relative movement of the at least one data carrier and/or the data carrier stack and the data readout device. By inducing thus relative movement which may be or may comprise a translational and/or a rotational movement, a subsequent readout of different portions of the data carrier by the data readout device may be enabled, such as by subsequently scanning the data carrier and/or the data carriers as particularly comprised within the data carrier stack with the light beam. Various types of actuators are feasible. Thus, as an example, a linear actuator such as an actuator moving the data readout device or a part thereof in a radial direction of one or more disk shaped data carriers is possible. Additionally or alternatively, a rotational actuator may be used, such as for rotating the at least one data carrier, preferably the one or more disk shaped data carriers. These actuators are generally known in the art of information technology, such as from CD, DVD or Blu-ray devices.

In a further aspect of the present invention, a method for reading out data from a data carrier is disclosed. The method comprises the following method steps which may be performed in the given order or in a different order. Further, two or more or even all of the method steps may be performed sequentially or at least partially simultaneously. Further, one, two or more or even all of the method steps may be performed once or repeatedly. The method may further comprise additional method steps. The method steps comprised by the method are as follows:
a) providing at least one data carrier, i.e. a single data carrier or at least two separate data carriers, having data modules located at at least two different depths within the data carrier;
b) providing a data readout device comprising:
   at least one illumination source for directing at least one light beam onto the data carrier;
   at least one detector adapted for detecting at least one modified light beam modified by at least one of the data modules, the detector having at least one optical sensor, wherein the optical sensor has at least one sensor region, wherein the optical sensor is designed to generate at least one sensor signal in a manner dependent on an illumination of the sensor region by the modified light beam, wherein the sensor signal, given the same total power of the illumination, is dependent on a beam cross-section of the modified light beam in the sensor region; and
c) evaluating the at least one sensor signal and deriving data stored in the data carrier from the sensor signal.

For further details, definitions or potential embodiments, reference may be made to the data readout device and to the data storage system as disclosed above or as disclosed in further detail below.

Specifically, step c) may comprise determining the depth of the data module within the particular data carrier from which the modified light beam originates, by evaluating the at least one sensor signal. Therein, a beam cross-section of the modified light beam in the sensor region may be determined by evaluating the sensor signal and by taking into account known beam properties of the light beam, thereby deriving the depth of the data module from which the modified light beam originates. Specifically, at least one known correlation between the at least one sensor signal and the depth of the data module within the particular data carrier from which the modified light beam originates may be used. As outlined above, in step c), sensor signals provided by the optical sensor may be classified according to the respective depths of the data modules.

In a further aspect of the present invention, a use of an optical sensor for reading out data is disclosed. Therein, the optical sensor has at least one sensor region, wherein the optical sensor is designed to generate at least one sensor signal in a manner dependent on an illumination of the sensor region by a light beam, wherein the sensor signal, given the same total power of the illumination, is dependent on a beam cross-section of the modified light beam in the sensor region. Thus, generally, the use of a FiP sensor for reading out data from a data carrier is proposed. Specifically, the optical sensor may be or may comprise at least one organic photodetector, preferably an organic solar cell, more preferably a dye-sensitized organic solar cell and most preferably a solid dye-sensitized organic solar cell. The optical sensor may comprise at least one photosensitive layer setup, the photosensitive layer setup preferably having at least one first electrode, at least one second electrode and at least one photovoltaic material sandwiched in between the first electrode and the second electrode, wherein the photovoltaic material may comprise at least one organic material. More specifically, the photosensitive layer setup may comprise an n-semiconducting metal oxide, preferably a nanoporous n-semiconducting metal oxide, wherein the photosensitive layer setup further may comprise at least one solid p-semiconducting organic material deposited on top of the n-semiconducting metal oxide. The n-semiconducting metal oxide may be sensitized by using at least one dye. At least one of the first electrode of the second electrode may be fully or partially transparent. As already mentioned, other kinds of optical sensors, in particular optical sensors which comprise an inorganic sensor material, may also be applicable. For further details of the optical sensor, reference may be made to the embodiments given above or given in further detail below.

As an example, the optical sensor may comprise at least one substrate and at least one photosensitive layer setup disposed thereon. As used herein, the expression “substrate” generally refers to a carrier element providing mechanical stability to the optical sensor. As will be outlined in further detail below, the substrate may be a transparent substrate and/or an intransparent substrate. As an example, the substrate may be a plate-shaped substrate, such as a slide and/or a foil. The substrate generally may have a thickness of 100 μm to 5 mm, preferably a thickness of 500 μm to 2 mm. However, other thicknesses are feasible.

As further used herein, a “photosensitive layer” setup generally refers to an entity having two or more layers which, generally, has light-sensitive properties. Thus, the photosensitive layer setup is capable of converting light in one or more of the visible, the ultraviolet or the infrared spectral range into an electrical signal. For this purpose, a large number of physical and/or chemical effects may be used, such as photo effects and/or excitation of organic molecules and/or formation of excited species within the photosensitive layer setup.

The photosensitive layer setup may have at least one first electrode, at least one second electrode and at least one photovoltaic material sandwiched in between the first electrode and the second electrode. As will be outlined in further detail below, the photosensitive layer setup may be embodied such that the first electrode is closest to the substrate and, thus, is embodied as a bottom electrode. Alternatively, the second electrode may be closest to the substrate and, thus, may be embodied as a bottom electrode. Generally, the expressions “first” and “second”, as used herein, are used for identification purposes only, without intending any ranking and/or without intending to denote any order of the photosensitive layer setup. Generally, the term “electrode” refers to an element of the photosensitive layer setup capable of electrically contacting the at least one photovoltaic material sandwiched in between the electrodes. Thus, each electrode may provide one or more layers and/or fields of an electrically conductive material contacting the photovoltaic material. Additionally, each of the electrodes may provide additional electrical leads, such as one or more electrical leads for contacting the first electrode and/or the second electrode. Thus, each of the first and second electrodes may provide one or more contact pads for contacting the first electrode and/or the second electrode, respectively.

As used herein, a “photovoltaic material” generally is a material or a combination of materials providing the above-mentioned photosensitivity of the photosensitive layer setup. Thus, the photovoltaic material may provide one or more layers of material which, under illumination by light in one or more of the visible, the ultraviolet or the infrared spectral range, are capable of generating an electrical signal, preferably an electrical signal indicating an intensity of illumination. Thus, the photovoltaic material may comprise one or more photovoltaic material layers which, by itself or in combination, are capable of generating positive and/or negative charges in response to the illumination, such as electrons and/or holes. The photovoltaic material may comprise at least one organic material.

As used herein, the term “sandwiched” generally refers to the fact that the photovoltaic material, at least partially, is located in an intermediate space in between the first electrode and the second electrode, notwithstanding the fact that other regions of the photovoltaic material may exist, which are located outside the intermediate space in between the first electrode and the second electrode.

As outlined above, one of the first electrode and the second electrode may form a bottom electrode closest to the substrate, and the other one may form a top electrode facing away from the substrate. Further, the first electrode may be an anode of the photosensitive layer setup, and the second electrode may be a cathode of the photosensitive layer setup or vice versa.

Specifically, one of the first electrode and the second electrode may be a bottom electrode and the other of the first electrode and the second electrode may be a top electrode. The bottom electrode may be applied to the substrate directly or indirectly, wherein the latter e.g. may imply interposing one or more buffer layers or protection layers in between the bottom electrode and the substrate. The photovoltaic material may be applied to the bottom electrode and may at least partially cover the bottom electrode. As outlined above, one or more portions of the bottom electrode may remain uncovered by the at least one photovoltaic material, such as for contacting purposes. The top electrode may be applied to the photovoltaic material, such that one or more portions of the top electrode are located on top of the photovoltaic material. As further outlined above, one or more additional portions of the top electrode may be located elsewhere, such as for contacting purposes. Thus, as an example, the bottom electrode may comprise one or more contact pads, which remain uncovered by the photovoltaic material. Similarly, the top electrode may comprise one or more contact pads, wherein the contact pad preferably is located outside an area coated by the photovoltaic material.

As outlined above, the substrate may be intransparent or at least partially transparent. As used herein, the term “transparent” refers to the fact that, in one or more of the visible spectral range, the ultraviolet spectral range or the infrared spectral range, light may penetrate the substrate at least partially. Thus, in one or more of the visible spectral range, the infrared spectral range or the ultraviolet spectral range, the substrate may have a transparency of at least 10%, preferably at least 30% or, more preferably, at least 50%. As an example, a glass substrate, a quartz substrate, a transparent plastic substrate or other types of substrates may be used as transparent substrates. Further, multi-layer substrates may be used, such as laminates.

As outlined above, one or both of the first electrode of the second electrode may be transparent. Thus, depending on the direction of illumination of the optical sensor, the bottom electrode, the top electrode or both may be transparent. As an example, in case a transparent substrate is used, preferably, at least the bottom electrode is a transparent electrode. In case the bottom electrode is the first electrode and/or in case the bottom electrode functions as an anode, preferably, the bottom electrode comprises at least one layer of a transparent conductive oxide, such as indium-tin-oxide, zinc oxide, fluorine-doped tin oxide or a combination of two or more of these materials. In case a transparent substrate and a transparent bottom electrode are used, a direction of illumination of the optical sensor may be through the substrate. In case an intransparent substrate is used, the bottom electrode may be transparent or intransparent. Thus, as an example, an intransparent electrode may comprise one or more metal layers of generally arbitrary thickness, such as one or more layers of silver and/or other metals. As an example, the bottom electrode and/or the first electrode may have a work function of 3 eV to 6 eV.

As outlined above, the top electrode may be intransparent or transparent. In case an illumination of the optical sensor takes place through the substrate and the bottom electrode, the top electrode may be intransparent. In case an illumination takes place through the top electrode, preferably, the top electrode is transparent. Still, as will be outlined in further detail below, the whole optical sensor may be transparent, at least in one or more spectral ranges of light. In this case, both the bottom electrode and the top electrode may be transparent.

In order to create a transparent top electrode, various techniques may be used. Thus, as an example, the top electrode may comprise a transparent conductive oxide, such as zinc oxide. The transparent conductive oxide may be applied, as an example, by using appropriate physical vapor deposition techniques, such as sputtering, thermal evaporation and/or electron-beam evaporation. The top electrode, preferably the second electrode, may be a cathode. Alternatively, the top electrode may as well function as an anode. Specifically in case the top electrode functions as a cathode, the top electrode preferably comprises one or more metal layers, such as metal layers having a work function of preferably less than 4.5 eV, such as aluminum. In order to create a transparent metal electrode, thin metal layers may be used, such as metal layers having a thickness of less than 50 nm, more preferably less than 40 nm or even more preferably less than 30 nm. Using these metal thicknesses, a transparency at least in the visible spectral range may be created. In order to still provide sufficient electrical conductivity, the top electrode may, in addition to the one or more metal layers, comprise additional electrically conductive layers, such as one or more electrically conductive organic materials applied in between the metal layers and the at least one photovoltaic material. Thus, as an example, one or more layers of an electrically conductive polymer may be interposed in between the metal layer of the top electrode and the photovoltaic material.

As outlined above, the top electrode may be intransparent or transparent. In case a transparent top electrode is provided, several techniques are applicable, as partially explained above. Thus, as an example, the top electrode may comprise one or more metal layers. The at least one metal layer may have a thickness of less than 50 nm, preferably a thickness of less than 40 nm, more preferably a thickness of less than 30 nm or even a thickness of less than 25 nm or less than 20 nm. The metal layer may comprise at least one metal selected from the group consisting of: Ag, Al, Au, Pt, Cu. Additionally or alternatively, other metals and/or combinations of metals, such as combinations of two or more of the named metals and/or other metals may be used. Further, one or more alloys may be used, containing two or more metals. As an example, one or more alloys of the group consisting of NiCr, AlNiCr, MoNb and AlNd may be used. The use of other metals, however, is possible.

The top electrode may further comprise at least one electrically conductive polymer embedded in between the photovoltaic material and the metal layer. Various possibilities of electrically conductive polymers which are usable within the present invention exist. Thus, as an example, the electrically conductive polymer may be intrinsically electrically conductive. As an example, the electrically conductive polymer may comprise one or more conjugated polymers. As an example, the electrically conductive polymer may comprise at least one polymer selected from the group consisting of a poly-3,4-ethylenedioxythiophene (PEDOT), preferably PEDOT being electrically doped with at least one counter ion, more preferably PEDOT doped with sodium polystyrene sulfonate (PEDOT:PSS); a polyaniline (PAN I); a polythiophene.

The optical sensor may further comprise at least one encapsulation protecting one or more of the photovoltaic material, the first electrode or the second electrode at least partially from moisture. Thus, as an example, the encapsulation may comprise one or more encapsulation layers and/or may comprise one or more encapsulation caps. As an example, one or more caps selected from the group consisting of glass caps, metal caps, ceramic caps and polymer or plastic caps may be applied on top of the photosensitive layer setup in order to protect the photosensitive layer setup or at least a part thereof from moisture. Additionally or alternatively, one or more encapsulation layers may be applied, such as one or more organic and/or inorganic encapsulation layers. Still, contact pads for electrically contacting the bottom electrode and/or the top electrode may be located outside the cap and/or the one or more encapsulation layers, in order to allow for an appropriate electrical contacting of the electrodes.

As outlined above, the optical sensor or, in case a plurality of optical sensors is provided, at least one of the optical sensors may be embodied as a photovoltaic device, preferably an organic photovoltaic device. Thus, as an example, the optical sensor may form a dye-sensitized solar cell (DSC), more preferably a solid dye-sensitized solar cell (sDSC). Thus, as outlined above, the photovoltaic material preferably may comprise at least one n-semiconducting metal oxide, at least one dye and at least one solid p-semiconducting organic material. As further outlined above, the n-semiconducting metal oxide may be sub-divided into at least one dense layer or solid layer of the n-semiconducting metal oxide, functioning as a buffer layer on top of the first electrode. Additionally, the n-semiconducting metal oxide may comprise one or more additional layers of the same or another n-semiconducting metal oxide having nanoporous and/or nanoparticulate properties. The dye may sensitize the latter layer, by forming a separate dye layer on top of the nanoporous n-semiconducting metal oxide and/or by soaking at least part of the n-semiconducting metal oxide layer. Thus, generally, the nanoporous n-semiconducting metal oxide may be sensitized with the at least one dye, preferably with the at least one organic dye. However, other kinds of optical sensors, in particular optical sensors comprising an inorganic sensor material, may also be applicable.

Further, in case a sensor stack comprising at least two optical sensors is used, the optical sensors may have the same spectral sensitivity and/or may have differing spectral sensitivities. Thus, as an example, one of the imaging devices may have a spectral sensitivity in a first wavelength band, and another one of the imaging devices may have a spectral sensitivity in a second wavelength band, the first wavelength band being different from the second wavelength band. By evaluating signals and/or images generated with these imaging devices, a color information may be generated. In this context, it may be preferred using at least one transparent optical sensor within a stack of imaging devices. The spectral sensitivities of the imaging devices may be adapted in various ways. Thus, the at least one photovoltaic material comprised in the imaging devices may be adapted to provide a specific spectral sensitivity, such as by using different types of dyes. Thus, by choosing appropriate dyes, a specific spectral sensitivity of the imaging devices may be generated. Additionally or alternatively, other means for adjusting the spectral sensitivity of the imaging devices may be used. Thus, as an example, one or more wavelength-selective elements may be used and may be assigned to one or more of the imaging devices, such that the one or more wavelength-selective elements, by definition, become part of the respective imaging devices. As an example, one or more wavelength-selective elements may be used selected from the group consisting of a filter, preferably a color filter, a prism and a dichroitic mirror. Thus, generally, by using one or more of the above-mentioned means and/or other means, the imaging devices may be adjusted such that two or more of the imaging devices exhibit differing spectral sensitivities.

In the following, examples of the photosensitive layer setup, specifically with regard to materials which may be used within this photosensitive layer setup, are disclosed. As outlined above, in the following examples the photosensitive layer setup preferably is a photosensitive layer setup of a solar cell, more preferably an organic solar cell and/or a dye-sensitized solar cell (DSC), more preferably a solid dye-sensitized solar cell (sDSC). Other embodiments, however, such as optical sensors comprising an inorganic sensor material, are feasible.

As outlined above, preferably, the photosensitive layer setup comprises at least one photovoltaic material, such as at least one photovoltaic layer setup comprising at least two layers, sandwiched between the first electrode and the second electrode. Preferably, the photosensitive layer setup and the photovoltaic material comprise at least one layer of an n-semiconducting metal oxide, at least one dye and at least one p-semiconducting organic material. As an example, the photovoltaic material may comprise a layer setup having at least one dense layer of an n-semiconducting metal oxide such as titanium dioxide, at least one nanoporous layer of an n-semiconducting metal oxide contacting the dense layer of the n-semiconducting metal oxide, such as at least one nanoporous layer of titanium dioxide, at least one dye sensitizing the nanoporous layer of the n-semiconducting metal oxide, preferably an organic dye, and at least one layer of at least one p-semiconducting organic material, contacting the dye and/or the nanoporous layer of the n-semiconducting metal oxide.

The dense layer of the n-semiconducting metal oxide, as will be explained in further detail below, may form at least one barrier layer in between the first electrode and the at least one layer of the nanoporous n-semiconducting metal oxide. It shall be noted, however, that other embodiments are feasible, such as embodiments having other types of buffer layers.

The first electrode may be one of an anode or a cathode, preferably an anode. The second electrode may be the other one of an anode or a cathode, preferably a cathode. The first electrode preferably contacts the at least one layer of the n-semiconducting metal oxide, and the second electrode preferably contacts the at least one layer of the p-semiconducting organic material. The first electrode may be a bottom electrode, contacting a substrate, and the second electrode may be a top electrode facing away from the substrate. Alternatively, the second electrode may be a bottom electrode, contacting the substrate, and the first electrode may be the top electrode facing away from the substrate. Preferably, one or both of the first electrode and the second electrode are transparent.

In the following, some options regarding the first electrode, the second electrode and the photovoltaic material, preferably the layer setup comprising two or more photovoltaic materials, will be disclosed. It shall be noted, however, that other embodiments are feasible.

a) Substrate, First Electrode and n-Semiconductive Metal Oxide

Generally, for preferred embodiments of the first electrode and the n-semiconductive metal oxide, reference may be made to one or more of WO 2012/110924 A1 and WO 2014/097181, the full content of all of which is herewith included by reference. Other embodiments are feasible.

In the following, it shall be assumed that the first electrode is the bottom electrode directly or indirectly contacting the substrate. It shall be noted, however, that other setups are feasible, with the first electrode being the top electrode.

The n-semiconductive metal oxide which may be used in the photosensitive layer setup, such as in at least one dense film (also referred to as a solid film) of the n-semiconductive metal oxide and/or in at least one nanoporous film (also referred to as a nanoparticulate film) of the n-semiconductive metal oxide, may be a single metal oxide or a mixture of different oxides. It is also possible to use mixed oxides. The n-semiconductive metal oxide may especially be porous and/or be used in the form of a nanoparticulate oxide, nanoparticles in this context being understood to mean particles which have an average particle size of less than 0.1 micrometer. A nanoparticulate oxide is typically applied to a conductive substrate (i.e. a carrier with a conductive layer as the first electrode) by a sintering process as a thin porous film with large surface area.

Preferably, the optical sensor uses at least one transparent substrate. However, setups using one or more intransparent substrates are feasible.

The substrate may be rigid or else flexible. Suitable substrates (also referred to hereinafter as carriers) are, as well as metal foils, in particular plastic sheets or films and especially glass sheets or glass films. Particularly suitable electrode materials, especially for the first electrode according to the above-described, preferred structure, are conductive materials, for example transparent conductive oxides (TCOs), for example fluorine- and/or indium-doped tin oxide (FTO or ITO) and/or aluminum-doped zinc oxide (AZO), carbon nanotubes or metal films. Alternatively or additionally, it would, however, also be possible to use thin metal films which still have a sufficient transparency. In case an intransparent first electrode is desired and used, thick metal films may be used.

The substrate can be covered or coated with these conductive materials. Since generally, only a single substrate is required in the structure proposed, the formation of flexible cells is also possible. This enables a multitude of end uses which would be achievable only with difficulty, if at all, with rigid substrates, for example use in bank cards, garments, etc.

The first electrode, especially the TCO layer, may additionally be covered or coated with a solid or dense metal oxide buffer layer (for example of thickness 10 to 200 nm), in order to prevent direct contact of the p-type semiconductor with the TCO layer (see Peng et al., Coord. Chem. Rev. 248, 1479 (2004)). The use of solid p-semiconducting electrolytes, in the case of which contact of the electrolyte with the first electrode is greatly reduced compared to liquid or gel-form electrolytes, however, makes this buffer layer unnecessary in many cases, such that it is possible in many cases to dispense with this layer, which also has a current-limiting effect and can also worsen the contact of the n-semiconducting metal oxide with the first electrode. This enhances the efficiency of the components. On the other hand, such a buffer layer can in turn be utilized in a controlled manner in order to match the current component of the dye solar cell to the current component of the organic solar cell. In addition, in the case of cells in which the buffer layer has been dispensed with, especially in solid cells, problems frequently occur with unwanted recombinations of charge carriers. In this respect, buffer layers are advantageous in many cases specifically in solid cells.

As is well known, thin layers or films of metal oxides are generally inexpensive solid semiconductor materials (n-type semiconductors), but the absorption thereof, due to large bandgaps, is typically not within the visible region of the electromagnetic spectrum, but rather usually in the ultraviolet spectral region. For use in solar cells, the metal oxides therefore generally, as is the case in the dye solar cells, have to be combined with a dye as a photosensitizer, which absorbs in the wavelength range of sunlight, i.e. at 300 to 2000 nm, and, in the electronically excited state, injects electrons into the conduction band of the semiconductor. With the aid of a solid p-type semiconductor used additionally in the cell as an electrolyte, which is in turn reduced at the counter electrode, electrons can be recycled to the sensitizer, such that it is regenerated.

Of particular interest for use in organic solar cells are the semiconductors zinc oxide, tin dioxide, titanium dioxide or mixtures of these metal oxides. The metal oxides can be used in the form of nanocrystalline porous layers. These layers have a large surface area which is coated with the dye as a sensitizer, such that a high absorption of sunlight is achieved. Metal oxide layers which are structured, for example nanorods, give advantages such as higher electron mobilities or improved pore filling by the dye.

The metal oxide semiconductors can be used alone or in the form of mixtures. It is also possible to coat a metal oxide with one or more other metal oxides. In addition, the metal oxides may also be applied as a coating to another semiconductor, for example GaP, ZnP or ZnS.

Particularly preferred semiconductors are zinc oxide and titanium dioxide in the anatase polymorph, which is preferably used in nanocrystalline form.

In addition, the sensitizers can advantageously be combined with all n-type semiconductors which typically find use in these solar cells. Preferred examples include metal oxides used in ceramics, such as titanium dioxide, zinc oxide, tin(IV) oxide, tungsten(VI) oxide, tantalum(V) oxide, niobium(V) oxide, cesium oxide, strontium titanate, zinc stannate, complex oxides of the perovskite type, for example barium titanate, and binary and ternary iron oxides, which may also be present in nanocrystalline or amorphous form.

Due to the strong absorption that customary organic dyes and ruthenium, phthalocyanines and porphyrins have, even thin layers or films of the n-semiconducting metal oxide are sufficient to absorb the required amount of dye. Thin metal oxide films in turn have the advantage that the probability of unwanted recombination processes falls and that the internal resistance of the dye subcell is reduced. For the n-semiconducting metal oxide, it is possible with preference to use layer thicknesses of 100 nm up to 20 micrometers, more preferably in the range between 500 nm and approx. 3 micrometers.

b) Dye

In the context of the present invention, as usual in particular for DSCs, the terms “dye”, “sensitizer dye” and “sensitizer” are used essentially synonymously without any restriction of possible configurations. Numerous dyes which are usable in the context of the present invention are known from the prior art, and so, for possible material examples, reference may also be made to the above description of the prior art regarding dye solar cells. As a preferred example, one or more of the dyes disclosed in one or more of WO 2012/110924 A1 and WO 2014/097181, the full content of all of which is herewith included by reference. Additionally or alternatively, one or more of the dyes as disclosed in WO 2007/054470 A1 and/or WO 2012/085803 A1 may be used, the full content of which is included by reference, too.

Dye-sensitized solar cells based on titanium dioxide as a semiconductor material are described, for example, in U.S. Pat. No. 4,927,721, Nature 353, p. 737-740 (1991) and U.S. Pat. No. 5,350,644, and also Nature 395, p. 583-585 (1998) and EP-A-1 176 646. The dyes described in these documents can in principle also be used advantageously in the context of the present invention. These dye solar cells preferably comprise monomolecular films of transition metal complexes, especially ruthenium complexes, which are bonded to the titanium dioxide layer via acid groups as sensitizers.

Many sensitizers which have been proposed include metal-free organic dyes, which are likewise also usable in the context of the present invention. High efficiencies of more than 4%, especially in solid dye solar cells, can be achieved, for example, with indoline dyes (see, for example, Schmidt-Mende et al., Adv. Mater. 2005, 17, 813). U.S. Pat. No. 6,359,211 describes the use, also implementable in the context of the present invention, of cyanine, oxazine, thiazine and acridine dyes which have carboxyl groups bonded via an alkylene radical for fixing to the titanium dioxide semiconductor.

Particularly preferred sensitizer dyes in the dye solar cell proposed are the perylene derivatives, terrylene derivatives and quaterrylene derivatives described in DE 10 2005 053 995 A1 or WO 2007/054470 A1. Further, as outlined above, one or more of the dyes as disclosed in WO 2012/085803 A1 may be used. The use of these dyes, which is also possible in the context of the present invention, leads to photovoltaic elements with high efficiencies and simultaneously high stabilities.

The rylenes exhibit strong absorption in the wavelength range of sunlight and can, depending on the length of the conjugated system, cover a range from about 400 nm (perylene derivatives I from DE 10 2005 053 995 A1) up to about 900 nm (quaterrylene derivatives I from DE 10 2005 053 995 A1). Rylene derivatives I based on terrylene absorb, according to the composition thereof, in the solid state adsorbed onto titanium dioxide, within a range from about 400 to 800 nm. In order to achieve very substantial utilization of the incident sunlight from the visible into the near infrared region, it is advantageous to use mixtures of different rylene derivatives I. Occasionally, it may also be advisable to use different rylene homologs.

The rylene derivatives I can be fixed easily and in a permanent manner to the n-semiconducting metal oxide film. The bonding is effected via the anhydride function (x1) or the carboxyl groups —COON or —COO— formed in situ, or via the acid groups A present in the imide or condensate radicals ((x2) or (x3)). The rylene derivatives I described in DE 10 2005 053 995 A1 have good suitability for use in dye-sensitized solar cells in the context of the present invention.

It is particularly preferred when the dyes, at one end of the molecule, have an anchor group which enables the fixing thereof to the n-type semiconductor film. At the other end of the molecule, the dyes preferably comprise electron donors Y which facilitate the regeneration of the dye after the electron release to the n-type semiconductor, and also prevent recombination with electrons already released to the semiconductor.

For further details regarding the possible selection of a suitable dye, it is possible, for example, again to refer to DE 10 2005 053 995 A1. By way of example, it is possible especially to use ruthenium complexes, porphyrins, other organic sensitizers, and preferably rylenes.

The dyes can be fixed onto or into the n-semiconducting metal oxide film, such as the nanoporous n-semiconducting metal oxide layer, in a simple manner. For example, the n-semiconducting metal oxide films can be contacted in the freshly sintered (still warm) state over a sufficient period (for example about 0.5 to 24 h) with a solution or suspension of the dye in a suitable organic solvent. This can be accomplished, for example, by immersing the metal oxide-coated substrate into the solution of the dye.

If combinations of different dyes are to be used, they may, for example, be applied successively from one or more solutions or suspensions which comprise one or more of the dyes. It is also possible to use two dyes which are separated by a layer of, for example, CuSCN (on this subject see, for example, Tennakone, K. J., Phys. Chem. B. 2003, 107, 13758). The most convenient method can be determined comparatively easily in the individual case.

In the selection of the dye and of the size of the oxide particles of the n-semiconducting metal oxide, the organic solar cell should be configured such that a maximum amount of light is absorbed. The oxide layers should be structured such that the solid p-type semiconductor can efficiently fill the pores. For instance, smaller particles have greater surface areas and are therefore capable of adsorbing a greater amount of dyes. On the other hand, larger particles generally have larger pores which enable better penetration through the p-conductor.

c) p-Semiconducting Organic Material

As described above, the at least one photosensitive layer setup, such as the photosensitive layer setup of the DSC or sDSC, can comprise in particular at least one p-semiconducting organic material, preferably at least one solid p-semiconducting material, which is also designated hereinafter as p-type semiconductor or p-type conductor. Hereinafter, a description is given of a series of preferred examples of such organic p-type semiconductors which can be used individually or else in any desired combination, for example in a combination of a plurality of layers with a respective p-type semiconductor, and/or in a combination of a plurality of p-type semiconductors in one layer.

In order to prevent recombination of the electrons in the n-semiconducting metal oxide with the solid p-conductor, it is possible to use, between the n-semiconducting metal oxide and the p-type semiconductor, at least one passivating layer which has a passivating material. This layer should be very thin and should as far as possible cover only the as yet uncovered sites of the n-semiconducting metal oxide. The passivation material may, under some circumstances, also be applied to the metal oxide before the dye. Preferred passivation materials are especially one or more of the following substances: Al₂O₃; silanes, for example CH₃SiCl₃; Al³⁺; 4-tert-butylpyridine (TBP); MgO; GBA (4-guanidinobutyric acid) and similar derivatives; alkyl acids; hexadecylmalonic acid (HDMA).

As described above, preferably one or more solid organic p-type semiconductors are used—alone or else in combination with one or more further p-type semiconductors which are organic or inorganic in nature. In the context of the present invention, a p-type semiconductor is generally understood to mean a material, especially an organic material, which is capable of conducting holes, that is to say positive charge carriers. More particularly, it may be an organic material with an extensive π-electron system which can be oxidized stably at least once, for example to form what is called a free-radical cation. For example, the p-type semiconductor may comprise at least one organic matrix material which has the properties mentioned. Furthermore, the p-type semiconductor can optionally comprise one or a plurality of dopants which intensify the p-semiconducting properties. A significant parameter influencing the selection of the p-type semiconductor is the hole mobility, since this partly determines the hole diffusion length (cf. Kumara, G., Langmuir, 2002, 18, 10493-10495). A comparison of charge carrier mobilities in different spiro compounds can be found, for example, in T. Saragi, Adv. Funct. Mater. 2006, 16, 966-974.

Preferably, in the context of the present invention, organic semiconductors are used (i.e. one or more of low molecular weight, oligomeric or polymeric semiconductors or mixtures of such semiconductors). Particular preference is given to p-type semiconductors which can be processed from a liquid phase. Examples here are p-type semiconductors based on polymers such as polythiophene and polyarylamines, or on amorphous, reversibly oxidizable, nonpolymeric organic compounds, such as the spirobifluorenes mentioned at the outset (cf., for example, US 2006/0049397 and the spiro compounds disclosed therein as p-type semiconductors, which are also usable in the context of the present invention). Preference is also given to using low molecular weight organic semiconductors, such as the low molecular weight p-type semiconducting materials as disclosed in WO 2012/110924 A1, preferably spiro-MeOTAD, and/or one or more of the p-type semiconducting materials disclosed in Leijtens et al., ACS Nano, VOL. 6, NO. 2, 1455-1462 (2012). In addition, reference may also be made to the remarks regarding the p-semiconducting materials and dopants from the above description of the prior art.

The p-type semiconductor is preferably producible or produced by applying at least one p-conducting organic material to at least one carrier element, wherein the application is effected for example by deposition from a liquid phase comprising the at least one p-conducting organic material. The deposition can in this case once again be effected, in principle, by any desired deposition process, for example by spin-coating, doctor blading, knife-coating, printing or combinations of the stated and/or other deposition methods.

The organic p-type semiconductor may especially comprise at least one spiro compound such as spiro-MeOTAD and/or at least one compound with the structural formula:

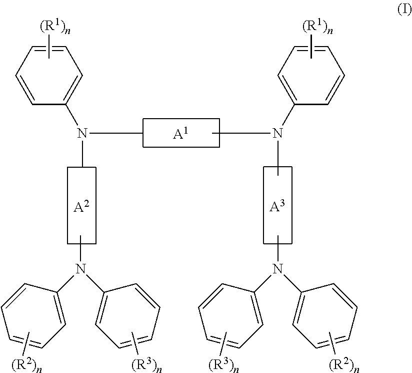

in which

A¹, A², A³ are each independently optionally substituted aryl groups or heteroaryl groups,

R¹, R², R³are each independently selected from the group consisting of the substituents —R, —OR, —NR₂, -A⁴—OR and -A⁴—NR₂,

where R is selected from the group consisting of alkyl, aryl and heteroaryl,

and

where A⁴ is an aryl group or heteroaryl group, and

where n at each instance in formula I is independently a value of 0, 1, 2 or 3,

with the proviso that the sum of the individual n values is at least 2 and at least two of the R¹, R² and R³ radicals are —OR and/or —NR₂.

Preferably, A² and A³ are the same; accordingly, the compound of the formula (I) preferably has the following structure (Ia)

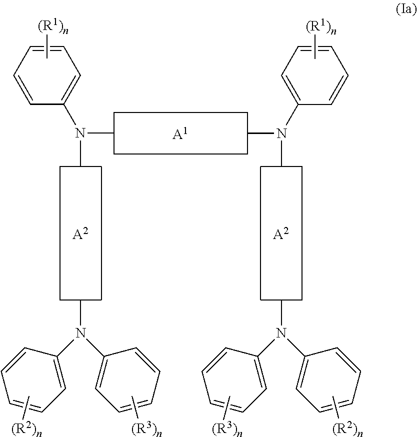

Additionally or alternatively, one or more organic p-type semiconductors as disclosed in JPH08292586 A may be used.

More particularly, as explained above, the p-type semiconductor may thus have at least one low molecular weight organic p-type semiconductor. A low molecular weight material is generally understood to mean a material which is present in monomeric, nonpolymerized or nonoligomerized form. The term “low molecular weight” as used in the present context preferably means that the p-type semiconductor has molecular weights in the range from 100 to 25,000 g/mol. Preferably, the low molecular weight substances have molecular weights of 500 to 2000 g/mol.

In general, in the context of the present invention, p-semiconducting properties are understood to mean the property of materials, especially of organic molecules, to form holes and to transport these holes and/or to pass them on to adjacent molecules. More particularly, stable oxidation of these molecules should be possible. In addition, the low molecular weight organic p-type semiconductors mentioned may especially have an extensive 7c-electron system. More particularly, the at least one low molecular weight p-type semiconductor may be processable from a solution. The low molecular weight p-type semiconductor may especially comprise at least one triphenylamine. It is particularly preferred when the low molecular weight organic p-type semiconductor comprises at least one spiro compound. A spiro compound is understood to mean polycyclic organic compounds whose rings are joined only at one atom, which is also referred to as the spiro atom. More particularly, the spiro atom may be spa-hybridized, such that the constituents of the spiro compound connected to one another via the spiro atom are, for example, arranged in different planes with respect to one another.

More preferably, the spiro compound has a structure of the following formula:

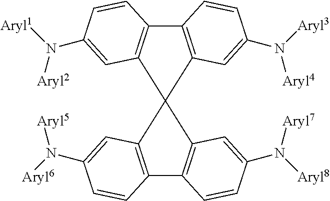

where the aryl¹, aryl², aryl³, aryl⁴, aryl⁵, aryl⁶, aryl⁷ and aryl⁸ radicals are each independently selected from substituted aryl radicals and heteroaryl radicals, especially from substituted phenyl radicals, where the aryl radicals and heteroaryl radicals, preferably the phenyl radicals, are each independently substituted, preferably in each case by one or more substituents selected from the group consisting of —O-alkyl, —OH, —F, —Cl, —Br and —I, where alkyl is preferably methyl, ethyl, propyl or isopropyl. More preferably, the phenyl radicals are each independently substituted, in each case by one or more substituents selected from the group consisting of —O-Me, —OH, —F, —Cl, —Br and —I.

Further preferably, the spiro compound is a compound of the following formula:

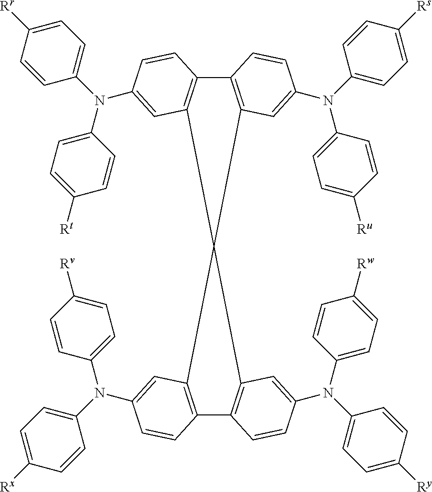

where R^{r}, R^{s}, R^{t}, R^{u}, R^{v}, R^{w}, R^{x} and R^{y} are each independently selected from the group consisting of —O-alkyl, —OH, —F, —Cl, —Br and —I, where alkyl is preferably methyl, ethyl, propyl or isopropyl. More preferably, R^{r}, R^{s}, R^{t}, R^{u}, R^{v}, R^{w}, R^{x} and R^{y} are each independently selected from the group consisting of —O-Me, —OH, —F, —Cl, —Br and —I. More particularly, the p-type semiconductor may comprise spiro-MeOTAD or consist of spiro-MeOTAD, i.e. a compound of the formula below, commercially available from Merck KGaA, Darmstadt, Germany:

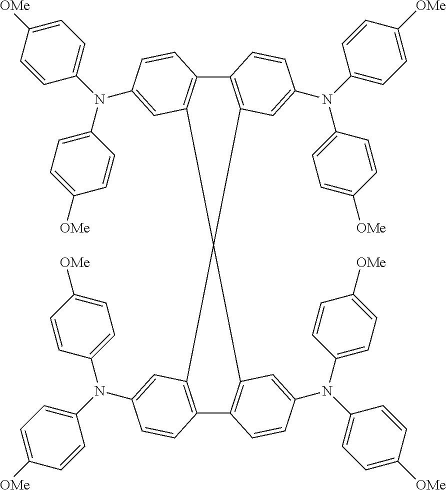 [SMILES: COc1ccc(N(c2ccc(OC)cc2)c2ccc3c(c2)C2(c4cc(N(c5ccc(OC)cc5)c5ccc(OC)cc5)ccc4-3)c3cc(N(c4ccc(OC)cc4)c4ccc(OC)cc4)ccc3-c3ccc(N(c4ccc(OC)cc4)c4ccc(OC)cc4)cc32)cc1]

Alternatively or additionally, it is also possible to use other p-semiconducting compounds, especially low molecular weight and/or oligomeric and/or polymeric p-semiconducting compounds.

In an alternative embodiment, the low molecular weight organic p-type semiconductor comprises one or more compounds of the above-mentioned general formula I, for which reference may be made, for example, to PCT application number PCT/EP2010/051826. The p-type semiconductor may comprise the at least one compound of the above-mentioned general formula I additionally or alternatively to the spiro compound described above.

The term “alkyl” or “alkyl group” or “alkyl radical” as used in the context of the present invention is understood to mean substituted or unsubstituted C₁-C₂₀-alkyl radicals in general. Preference is given to C₁- to C₁₀-alkyl radicals, particular preference to C₁- to C₈-alkyl radicals. The alkyl radicals may be either straight-chain or branched. In addition, the alkyl radicals may be substituted by one or more substituents selected from the group consisting of C1-C20-alkoxy, halogen, preferably F, and C₆-C₃₀-aryl which may in turn be substituted or unsubstituted. Examples of suitable alkyl groups are methyl, ethyl, propyl, butyl, pentyl, hexyl, heptyl and octyl, and also isopropyl, isobutyl, isopentyl, sec-butyl, tert-butyl, neopentyl, 3,3-dimethylbutyl, 2-ethylhexyl, and also derivatives of the alkyl groups mentioned substituted by C₆-C₃₀-aryl, C₁-C₂₀-alkoxy and/or halogen, especially F, for example CF₃.

The term “aryl” or “aryl group” or “aryl radical” as used in the context of the present invention is understood to mean optionally substituted C₆-C₃₀-aryl radicals which are derived from monocyclic, bicyclic, tricyclic or else multicyclic aromatic rings, where the aromatic rings do not comprise any ring heteroatoms. The aryl radical preferably comprises 5- and/or 6-membered aromatic rings. When the aryls are not monocyclic systems, in the case of the term “aryl” for the second ring, the saturated form (perhydro form) or the partly unsaturated form (for example the dihydro form or tetrahydro form), provided the particular forms are known and stable, is also possible. The term “aryl” in the context of the present invention thus comprises, for example, also bicyclic or tricyclic radicals in which either both or all three radicals are aromatic, and also bicyclic or tricyclic radicals in which only one ring is aromatic, and also tricyclic radicals in which two rings are aromatic. Examples of aryl are: phenyl, naphthyl, indanyl, 1,2-dihydronaphthenyl, 1,4-dihydronaphthenyl, fluorenyl, indenyl, anthracenyl, phenanthrenyl or 1,2,3,4-tetrahydronaphthyl. Particular preference is given to C₆-C₁₀-aryl radicals, for example phenyl or naphthyl, very particular preference to C₆-aryl radicals, for example phenyl. In addition, the term “aryl” also comprises ring systems comprising at least two monocyclic, bicyclic or multicyclic aromatic rings joined to one another via single or double bonds. One example is that of biphenyl groups.

The term “heteroaryl” or “heteroaryl group” or “heteroaryl radical” as used in the context of the present invention is understood to mean optionally substituted 5- or 6-membered aromatic rings and multicyclic rings, for example bicyclic and tricyclic compounds having at least one heteroatom in at least one ring. The heteroaryls in the context of the invention preferably comprise 5 to 30 ring atoms. They may be monocyclic, bicyclic or tricyclic, and some can be derived from the aforementioned aryl by replacing at least one carbon atom in the aryl base skeleton with a heteroatom. Preferred heteroatoms are N, O and S. The hetaryl radicals more preferably have 5 to 13 ring atoms. The base skeleton of the heteroaryl radicals is especially preferably selected from systems such as pyridine and five-membered heteroaromatics such as thiophene, pyrrole, imidazole or furan. These base skeletons may optionally be fused to one or two six-membered aromatic radicals. In addition, the term “heteroaryl” also comprises ring systems comprising at least two monocyclic, bicyclic or multicyclic aromatic rings joined to one another via single or double bonds, where at least one ring comprises a heteroatom. When the heteroaryls are not monocyclic systems, in the case of the term “heteroaryl” for at least one ring, the saturated form (perhydro form) or the partly unsaturated form (for example the dihydro form or tetrahydro form), provided the particular forms are known and stable, is also possible. The term “heteroaryl” in the context of the present invention thus comprises, for example, also bicyclic or tricyclic radicals in which either both or all three radicals are aromatic, and also bicyclic or tricyclic radicals in which only one ring is aromatic, and also tricyclic radicals in which two rings are aromatic, where at least one of the rings, i.e. at least one aromatic or one nonaromatic ring has a heteroatom. Suitable fused heteroaromatics are, for example, carbazolyl, benzimidazolyl, benzofuryl, dibenzofuryl or dibenzothiophenyl. The base skeleton may be substituted at one, more than one or all substitutable positions, suitable substituents being the same as have already been specified under the definition of C₆-C₃₀-aryl. However, the hetaryl radicals are preferably unsubstituted. Suitable hetaryl radicals are, for example, pyridin-2-yl, pyridin-3-yl, pyridin-4-yl, thiophen-2-yl, thiophen-3-yl, pyrrol-2-yl, pyrrol-3-yl, furan-2-yl, furan-3-yl and imidazol-2-yl and the corresponding benzofused radicals, especially carbazolyl, benzimidazolyl, benzofuryl, dibenzofuryl or dibenzothiophenyl.

In the context of the invention, the term “optionally substituted” refers to radicals in which at least one hydrogen radical of an alkyl group, aryl group or heteroaryl group has been replaced by a substituent. With regard to the type of this substituent, preference is given to alkyl radicals, for example methyl, ethyl, propyl, butyl, pentyl, hexyl, heptyl and octyl, and also isopropyl, isobutyl, isopentyl, sec-butyl, tert-butyl, neopentyl, 3,3-dimethylbutyl and 2-ethylhexyl, aryl radicals, for example C₆-C₁₀-aryl radicals, especially phenyl or naphthyl, most preferably C₆-aryl radicals, for example phenyl, and hetaryl radicals, for example pyridin-2-yl, pyridin-3-yl, pyridin-4-yl, thiophen-2-yl, thiophen-3-yl, pyrrol-2-yl, pyrrol-3-yl, furan-2-yl, furan-3-yl and imidazol-2-yl, and also the corresponding benzofused radicals, especially carbazolyl, benzimidazolyl, benzofuryl, dibenzofuryl or dibenzothiophenyl. Further examples include the following substituents: alkenyl, alkynyl, halogen, hydroxyl.

The degree of substitution here may vary from monosubstitution up to the maximum number of possible substituents.

Preferred compounds of the formula I for use in accordance with the invention are notable in that at least two of the R¹, R² and R³ radicals are para-OR and/or —NR₂ substituents. The at least two radicals here may be only —OR radicals, only —NR₂ radicals, or at least one —OR and at least one —NR₂ radical.

Particularly preferred compounds of the formula I for use in accordance with the invention are notable in that at least four of the R¹, R² and R³ radicals are para-OR and/or —NR₂substituents. The at least four radicals here may be only —OR radicals, only —NR₂ radicals or a mixture of —OR and —NR₂ radicals.

Very particularly preferred compounds of the formula I for use in accordance with the invention are notable in that all of the R¹, R² and R³ radicals are para-OR and/or —NR₂ substituents. They may be only —OR radicals, only —NR₂ radicals or a mixture of —OR and —NR₂ radicals.

In all cases, the two R in the —NR₂ radicals may be different from one another, but they are preferably the same.

Preferably, A¹, A² and A³ are each independently selected from the group consisting of

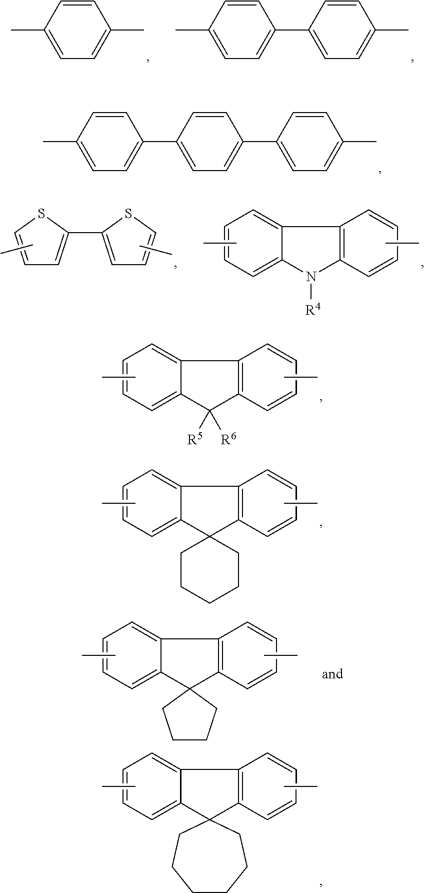

in which

m is an integer from 1 to 18,

R⁴ is alkyl, aryl or heteroaryl, where R⁴ is preferably an aryl radical, more preferably a phenyl radical,

R⁵, R⁶ are each independently H, alkyl, aryl or heteroaryl,

where the aromatic and heteroaromatic rings of the structures shown may optionally have further substitution. The degree of substitution of the aromatic and heteroaromatic rings here may vary from monosubstitution up to the maximum number of possible substituents.

Preferred substituents in the case of further substitution of the aromatic and heteroaromatic rings include the substituents already mentioned above for the one, two or three optionally substituted aromatic or heteroaromatic groups.

Preferably, the aromatic and heteroaromatic rings of the structures shown do not have further substitution.

More preferably, A¹, A² and A³ are each independently

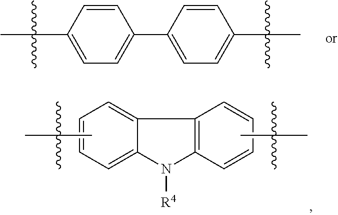

more preferably

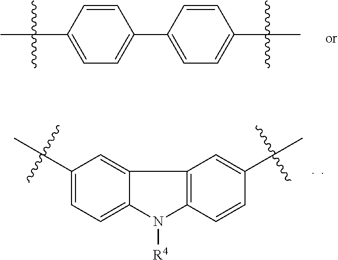

More preferably, the at least one compound of the formula (I) has one of the following structures

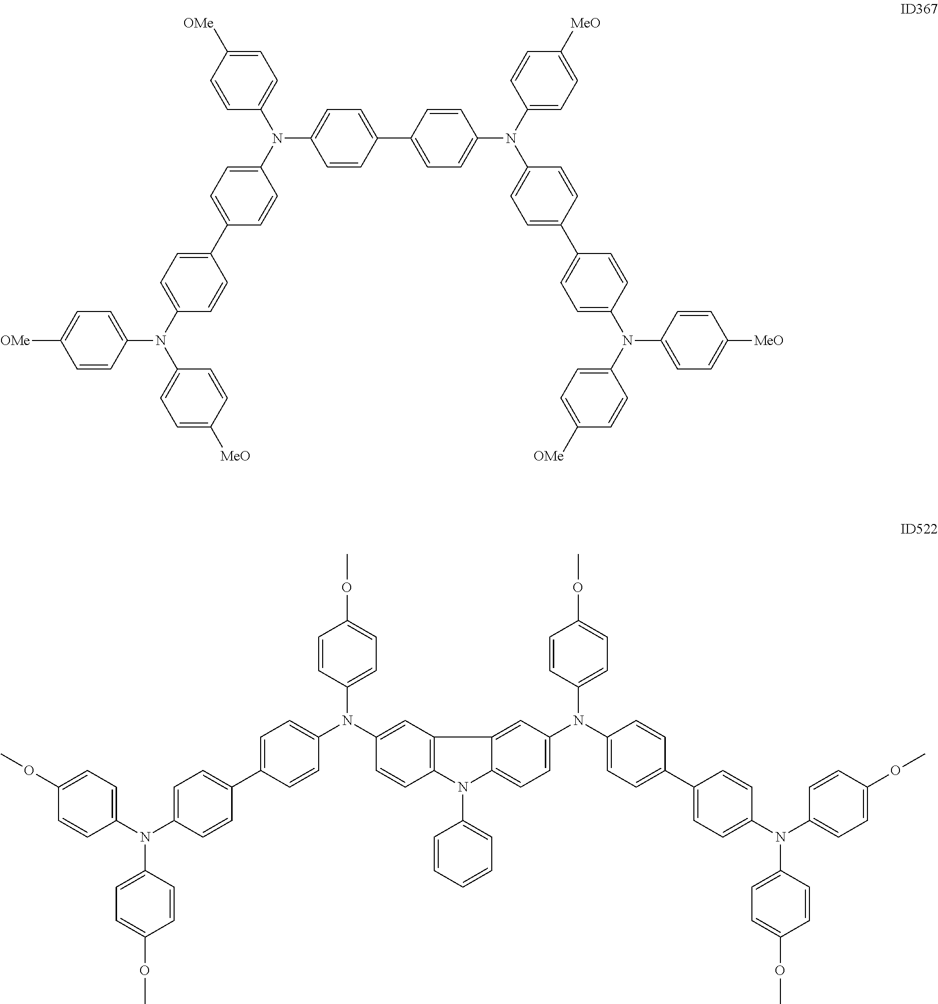

In an alternative embodiment, the organic p-type semiconductor comprises a compound of the type ID322 having the following structure:

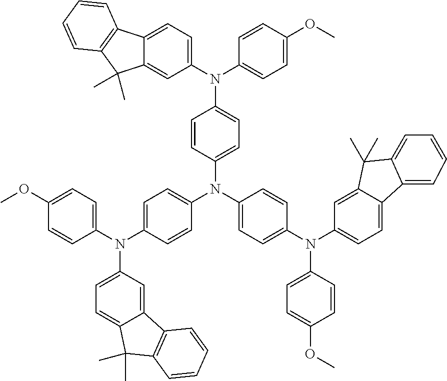 [SMILES: COc1ccc(N(c2ccc(N(c3ccc(N(c4ccc(OC)cc4)c4ccc5c(c4)C(C)(C)c4ccccc4-5)cc3)c3ccc(N(c4ccc(OC)cc4)c4ccc5c(c4)C(C)(C)c4ccccc4-5)cc3)cc2)c2ccc3c(c2)-c2ccccc2C3(C)C)cc1]

The compounds for use in accordance with the invention can be prepared by customary methods of organic synthesis known to those skilled in the art. References to relevant (patent) literature can additionally be found in the synthesis examples adduced below.

d) Second Electrode

The second electrode may be a bottom electrode facing the substrate or else a top electrode facing away from the substrate. As outlined above, the second electrode may be fully or partially transparent or, else, may be intransparent. As used herein, the term partially transparent refers to the fact that the second electrode may comprise transparent regions and intransparent regions.

One or more materials of the following group of materials may be used: at least one metallic material, preferably a metallic material selected from the group consisting of aluminum, silver, platinum, gold; at least one nonmetallic inorganic material, preferably LiF; at least one organic conductive material, preferably at least one electrically conductive polymer and, more preferably, at least one transparent electrically conductive polymer.

The second electrode may comprise at least one metal electrode, wherein one or more metals in pure form or as a mixture/alloy, such as especially aluminum or silver may be used.

Additionally or alternatively, nonmetallic materials may be used, such as inorganic materials and/or organic materials, both alone and in combination with metal electrodes. As an example, the use of inorganic/organic mixed electrodes or multilayer electrodes is possible, for example the use of LiF/Al electrodes. Additionally or alternatively, conductive polymers may be used. Thus, the second electrode of the optical sensor preferably may comprise one or more conductive polymers.

Thus, as an example, the second electrode may comprise one or more electrically conductive polymers, in combination with one or more layers of a metal. Preferably, the at least one electrically conductive polymer is a transparent electrically conductive polymer. This combination allows for providing very thin and, thus, transparent metal layers, by still providing sufficient electrical conductivity in order to render the second electrode both transparent and highly electrically conductive. Thus, as an example, the one or more metal layers, each or in combination, may have a thickness of less than 50 nm, preferably less than 40 nm or even less than 30 nm.

As an example, one or more electrically conductive polymers may be used, selected from the group consisting of: polyanaline (PANI) and/or its chemical relatives; a polythiophene and/or its chemical relatives, such as poly(3-hexylthiophene) (P3HT) and/or PEDOT:PSS (poly(3,4-ethylenedioxythiophene) poly(styrenesulfonate)). Additionally or alternatively, one or more of the conductive polymers as disclosed in EP2507286 A2, EP2205657 A1 or EP2220141 A1. For further exemplary embodiments, reference may be made to U.S. provisional application No. 61/739,173 or U.S. provisional application No. 61/708,058, the full content of all of which is herewith included by reference.

In addition or alternatively, inorganic conductive materials may be used, such as inorganic conductive carbon materials, such as carbon materials selected from the group consisting of: graphite, graphene, carbon nanotubes, carbon nanowires.

In addition, it is also possible to use electrode designs in which the quantum efficiency of the components is increased by virtue of the photons being forced, by means of appropriate reflections, to pass through the absorbing layers at least twice. Such layer structures are also referred to as “concentrators” and are likewise described, for example, in WO 02/101838 (especially pages 23-24).

In the following, some exemplary embodiments of the optical sensor and the sensor stack comprising two or more optical sensors and of potential evaluation techniques are explained.

As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signal, such as one or more AD-converters and/or one or more filters and/or one or more signal preamplifiers or amplifiers. As an example, S. W. Kettlitz, S. Valouch, W. Sittel and U. Lemmer, Flexible planar microfluidic chip employing a light emitting diode and a PIN photodiode for portable flow cytometers, Lab Chip, 2012, p. 197-203, disclose a preamplifier which could be comprised within the evaluation device for this purpose. As described therein, the preamplifier may preferably comprise a differential amplifier stage configured for minimizing noise which may originate from a possible electrical interference, such as from a second optical sensor, and a high-pass filter adapted for removing a DC offset which may, for example, be caused by a residual light source, such as ambient light. Further, the evaluation device may comprise one or more data storage devices. Further, the evaluation device may comprise one or more interfaces, such as one or more wireless interfaces and/or one or more wire-bound interfaces.

The at least one evaluation device may be adapted to perform at least one computer program, such as at least one computer program evaluating the at least one sensor signal and/or for performing or supporting retrieving and/or decoding of data stored in the data carrier.

As outlined above, the at least one sensor signal, given the same total power of the illumination by the light beam, is dependent on a beam cross-section of the modified light beam in the sensor region of the at least one optical sensor. As used herein, the term beam cross-section generally refers to a lateral extension of the light beam or a light spot generated by the light beam at a specific location. In case a circular light spot is generated, a radius, a diameter or a Gaussian beam waist or twice the Gaussian beam waist may function as a measure of the beam cross-section. In case non-circular light spots are generated, the cross-section may be determined in any other feasible way, such as by determining the cross-section of a circle having the same area as the non-circular light spot, which is also referred to as the equivalent beam cross-section.

Thus, given the same total power of the illumination of the sensor region by the light beam, a light beam having a first beam diameter or beam cross-section may generate a first sensor signal, whereas a light beam having a second beam diameter or beam-cross section being different from the first beam diameter or beam cross-section generates a second sensor signal being different from the first sensor signal. Thus, by comparing the sensor signals, an item of information or at least one item of information on the beam cross-section, specifically on the beam diameter, may be generated. For details of this effect, reference may be made to one or more of WO 2012/110924 A1 or WO 2014/097181. Specifically in case one or more beam properties of the light beam, the transmitted light beam, or the reflected light beam are known, the depth of the data module by which the light beam is fully or partially reflected and/or absorbed may thus be derived from a known relationship between the at least one sensor signal and a depth of the respective data module. The known relationship may be stored in the evaluation device as an algorithm and/or as one or more calibration curves. As an example, specifically for Gaussian beams, a relationship between a beam diameter or beam waist and the respective depth may easily be derived by using the Gaussian relationship between the beam waist and the depth.

The above-mentioned effect, which is also referred to as the FiP-effect (alluding to the effect that the beam cross section φ influences the electric power P generated by the optical sensor), may depend on or may be emphasized by an appropriate modulation of the light beam, as disclosed in one or more of WO 2012/110924 A1 and WO 2014/097181. Thus, optionally, the detector may furthermore have at least one modulation device for modulating the at least one light beam or the at least one modified light beam. The modulation device may fully or partially be implemented into the at least one illumination source and/or may fully or partially be designed as a separate modulation device. By way of example, the detector can be designed to bring about a modulation of the modified light beam with a frequency of 0.05 Hz to 1 MHz, such as 0.1 Hz to 10 kHz, specifically for the purpose of the FiP effect.

The modulation of the light beam or the modified light beam may take place in different frequency ranges and/or may be established in various ways. Thus, the detector can furthermore have at least one modulation device. Generally, a modulation of a light beam should be understood to mean a process in which a total power and/or a phase, most preferably a total power, of the respective light beam is varied, preferably periodically, in particular with one or a plurality of modulation frequencies. In particular, a periodic modulation can be effected between a maximum value and a minimum value of the total power of the illumination. The minimum value can be 0, but can also be >0, such that, by way of example, complete modulation does not have to be effected. The modulation can be effected for example in a beam path between the illumination source and the data carrier and/or in between the data carrier and the at least one optical sensor. Alternatively or additionally, the modulation may also be performed by the illumination source itself. The at least one modulation device can comprise for example a beam chopper or some other type of periodic beam interrupting device, for example comprising at least one interrupter blade or interrupter wheel, which preferably rotates at constant speed and which can thus periodically interrupt the illumination. Alternatively or additionally, however, it is also possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by said illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Thus, the data readout device generally may be designed such that one or both of the light beam illuminating the data carrier or the modified light beam are modulated. Various possibilities are conceivable.

The detector may be designed to detect at least two sensor signals in the case of different modulations, in particular at least two sensor signals at respectively different modulation frequencies. In this case, the evaluation device may be designed to generate the at least one item of information on the depth of the data module by evaluating the at least two sensor signals.

Generally, the optical sensor may be designed in such a way that the at least one sensor signal, given the same total power of the illumination, is dependent on a modulation frequency of a modulation of the illumination by the modified light beam. Further details and exemplary embodiments will be given below. This property of frequency dependency is specifically provided in DSCs and, more preferably, in sDSCs. However, other types of optical sensors, preferably photo detectors and, more preferably, organic photo detectors may exhibit this effect.

Preferably, the at least one optical sensor is a thin film device, having a layer setup with a thickness of preferably no more than 1 mm, more preferably of at most 500 μm or even less. Thus, the sensor region of the optical sensor may be or may comprise a sensor area, which may be formed by a surface of the respective device facing towards the object.

Preferably, the sensor region of the optical sensor may be formed by one continuous sensor region, such as one continuous sensor area or sensor surface per device. Thus, preferably, the sensor region of the optical sensor or, in case a plurality of optical sensors is provided (such as a stack of optical sensors), each sensor region of the optical sensor, may be formed by exactly one continuous sensor region. The sensor signal preferably is a uniform sensor signal for the entire sensor region of the optical sensor or, in case a plurality of optical sensors is provided, is a uniform sensor signal for each sensor region of each optical sensor.

As outlined above, the detector preferably has a plurality of the optical sensors. More preferably, the plurality of optical sensors is stacked, such as along the optical axis of the detector. Thus, the optical sensors may form a sensor stack. The sensor stack preferably may be oriented such that the sensor regions of the optical sensors are oriented perpendicular to the optical axis. Thus, as an example, sensor areas or sensor surfaces of the single optical sensors may be oriented in parallel, wherein slight angular tolerances might be tolerable, such as angular tolerances of no more than 10°, preferably of no more than 5°.

The optical sensors preferably are arranged such that the modified light beam illuminates all optical sensors, preferably sequentially. Specifically in this case, preferably, at least one sensor signal is generated by each optical sensor. This embodiment is specifically preferred since the stacked setup of the optical sensors allows for an easy and efficient normalization of the sensor signals, even if an overall power or intensity of the modified light beam is unknown. Thus, the single sensor signals may be known to be generated by one and the same modified light beam.

Thus, the evaluation device may be adapted to normalize the sensor signals and to generate the information on depth of the modified data module independent from an intensity of the light beam. For this purpose, use may be made of the fact that, in case the single sensor signals are generated by one and the same light beam, differences in the single sensor signals are only due to differences in the cross-sections of the light beam at the location of the respective sensor regions of the single optical sensors. Thus, by comparing the single sensor signals, information on a beam cross-section may be generated even if the overall power of the light beam is unknown. From the beam cross-section, information regarding the depth may be gained, specifically by making use of a known relationship between the cross-section of the light beam and the depth.

Further, the above-mentioned stacking of the optical sensors and the generation of a plurality of sensor signals by these stacked optical sensors may be used by the evaluation device in order to resolve an ambiguity in a known relationship between a beam cross-section of the light beam and the depth.

Overall, in the context of the present invention, the following embodiments are regarded as preferred:

Embodiment 1: A data readout device for reading out data from at least one data carrier having data modules located at at least two different depths within the at least one data carrier, the data readout device comprising:
at least one illumination source for directing at least one light beam onto the data carrier;
at least one detector adapted for detecting at least one modified light beam modified by at least one of the data modules, the detector having at least one optical sensor, wherein the optical sensor has at least one sensor region, wherein the optical sensor is designed to generate at least one sensor signal in a manner dependent on an illumination of the sensor region by the modified light beam, wherein the sensor signal, given the same total power of the illumination, is dependent on a beam cross-section of the modified light beam in the sensor region; and
at least one evaluation device adapted for evaluating the at least one sensor signal and for deriving data stored in the at least one data carrier from the sensor signal.

Embodiment 2: The data readout device according to the preceding embodiment, wherein modifying the light beam comprises at least one of reflecting the light beam by the data modules within the data carrier or transmitting the light beam through the data carrier, wherein the data modules influence the light beam.

Embodiment 3: The data readout device according to any one of the preceding embodiments, having reflective data modules located at at least two different depths within the data carrier, the data readout device comprising:
at least one illumination source for directing at least one light beam onto the data carrier;
at least one detector adapted for detecting at least one reflected light beam reflected by at least one of the reflective data modules, the detector having at least one optical sensor, wherein the optical sensor has at least one sensor region, wherein the optical sensor is designed to generate at least one sensor signal in a manner dependent on an illumination of the sensor region by the reflected light beam, wherein the sensor signal, given the same total power of the illumination, is dependent on a beam cross-section of the reflected light beam in the sensor region; and
at least one evaluation device adapted for evaluating the at least one sensor signal and for deriving data stored in the data carrier from the sensor signal.

Embodiment 4: The data readout device according to any one of the preceding embodiments, wherein the data modules are reflective data modules, wherein the light beam directed onto the data carrier is modified by being reflected by at least one of the reflective data modules.

Embodiment 5: The data readout device according to any one of the preceding embodiments, wherein a transmitted light beam is generated by at least one of the data modules being capable of modifying the light beam directed onto the data carrier, wherein a transfer device focuses the light beam onto one of the depths where the data modules are located.

Embodiment 6: The data readout device according to the preceding embodiment, wherein the evaluation device is adapted to determine the depth of the data module from which the modified light beam originates, by evaluating the at least one sensor signal.

Embodiment 7: The data readout device according to the preceding embodiment, wherein the evaluation device is adapted to determine a beam cross-section of the modified light beam in the sensor region by evaluating the sensor signal and by taking into account known beam properties of the light beam, thereby deriving the depth of the data module from which the modified light beam originates.

Embodiment 8: The data readout device according to any one of the two preceding embodiments, wherein the evaluation device is adapted to use at least one known correlation between the at least one sensor signal and the depth of the data module from which the modified light beam originates.

Embodiment 9: The data readout device according to any one of the preceding embodiments, wherein the evaluation device is adapted to classify sensor signals provided by the optical sensor according to the respective depths of the data modules.

Embodiment 10: The data readout device according to any one of the preceding embodiments, wherein the optical sensor is an organic photodetector, preferably an organic solar cell, more preferably a dye-sensitized organic solar cell and most preferably a solid dye-sensitized organic solar cell.

Embodiment 11: The data readout device according to any one of the preceding embodiments, wherein the optical sensor comprises at least one photosensitive layer setup, the photosensitive layer setup having at least one first electrode, at least one second electrode and at least one photovoltaic material sandwiched in between the first electrode and the second electrode, wherein the photovoltaic material comprises at least one organic material.

Embodiment 12: The data readout device according to the preceding embodiment, wherein the photosensitive layer setup comprises an n-semiconducting metal oxide, preferably a nanoporous n-semiconducting metal oxide, wherein the photosensitive layer setup further comprises at least one solid p-semiconducting organic material deposited on top of the n-semiconducting metal oxide.

Embodiment 13: The data readout device according to the preceding embodiment, wherein the n-semiconducting metal oxide is sensitized by using at least one dye.

Embodiment 14: The data readout device according to any one of the three preceding embodiments, wherein at least one of the first electrode or the second electrode are fully or partially transparent.

Embodiment 15: The data readout device according to any one of the preceding embodiments, wherein the detector further comprises at least one further transfer device adapted for transferring the modified light beam to the at least one optical sensor.

Embodiment 16: The data readout device according to the preceding embodiment, wherein the transfer device comprises at least one lens or lens system.

Embodiment 17: The data readout device according to any one of the preceding embodiments, wherein the detector comprises a sensor stack of at least two optical sensors.

Embodiment 18: The data readout device according to the preceding embodiment, wherein at least one optical sensor of the sensor stack is at least partially transparent.

Embodiment 19: The data readout device according to any one of the two preceding embodiments, wherein the evaluation device is adapted to evaluate at least the sensor signals generated by at least two of the optical sensors of the sensor stack.

Embodiment 20: The data readout device according to the preceding embodiment, wherein the evaluation device is adapted to derive at least one beam parameter from the at least two sensor signals generated by the at least two optical sensors of the sensor stack.

Embodiment 21: The data readout device according to any one of the preceding embodiments, wherein the illumination source comprises at least one laser.

Embodiment 22: The data readout device according to any one of the preceding embodiments, wherein the illumination source is adapted to generate at least two different light beams having different colors.

Embodiment 23: The data readout device according to the preceding embodiment, wherein the detector is adapted for distinguishing modified light beams having different colors.

Embodiment 24: The data readout device according to the preceding embodiment, wherein the detector comprises at least two optical sensors having differing spectral sensitivities.

Embodiment 25: A data storage system, comprising at least one data readout device according to any one of the preceding embodiments, the data storage system further comprising at least one data carrier having data modules located at at least two different depths within the data carrier.

Embodiment 26: The data storage system according to the preceding embodiment, wherein the data carrier comprises at least one data carrier matrix material, wherein the data modules are one or both of contained in a layer of a material coated onto the matrix material and/or embedded within the matrix material.

Embodiment 27: The data storage system according to the preceding embodiment, wherein the matrix material is selected from the group consisting of: a polycarbonate; a polystyrene; a polyester; polyethylene terephthalate (PET); polyamide; poly(methyl-methacrylate) (PMMA).

Embodiment 28: The data storage system according to any one of the preceding embodiments, wherein the data carrier comprises a layer setup, the layer setup having at least two different information layers, wherein the data modules are located in the at least two different information layers.

Embodiment 29: The data storage system according to the preceding embodiment, wherein the information layers are planar layers.

Embodiment 30: The data storage system according to any one of the preceding embodiments referring to a data storage system, wherein the data carrier has a disk shape.

Embodiment 31: The data storage system according to any one of the preceding embodiments referring to a data storage system, wherein the data modules are arranged in tracks.

Embodiment 32: The data storage system according to the preceding embodiment, wherein the tracks are spiral tracks or concentric tracks.

Embodiment 33: The data storage system according to any one of the preceding embodiments referring to a data storage system, wherein the data modules are arranged in a three-dimensional arrangement.

Embodiment 34: The data storage system according to the preceding embodiment, wherein the three-dimensional arrangement is a circular or rectangular matrix arrangement.

Embodiment 35: The data storage system according to any one of the two preceding embodiments, wherein the three-dimensional arrangement contains at least three information layers.

Embodiment 36: The data storage system according to any one of the preceding embodiments referring to a data storage system, wherein the data storage system further comprises at least one actuator for inducing a relative movement of the data carrier and the data readout device.

Embodiment 37: The data storage system according to the preceding embodiment, wherein the relative movement comprises a rotational movement of the data carrier.

Embodiment 38: The data storage system according to any one of the preceding embodiments referring to a data storage system, wherein the data carrier has reflective data modules.

Embodiment 39: The data storage system according to the preceding embodiment, wherein the data modules are one or both of contained in a layer of an at least partially reflective material coated onto the matrix material and/or embedded within the matrix material.

Embodiment 40: The data storage system according to any one of the two preceding embodiments, wherein the information layers are made of at least one at least partially reflective material.

Embodiment 41: The data storage system according to any one of the three preceding embodiments, wherein the reflective data modules contain one or more of: local deformations in the information layers, local perforations in the information layers, local changes of a reflection of the information layers, local changes of an index of refraction of the information layers.

Embodiment 42: The data storage system according to any one of the preceding embodiments referring to a data storage system, wherein the data carrier has data modules which are configured to modify a transmission of the light beam traversing the data carrier.

Embodiment 43: The data storage system according to the preceding embodiment, wherein the data modules comprise an arrangement of small areas located within the information layer and capable of disturbing the incident light beam in a manner that the transmission of the incident light beam is diminished by the respective data modules.

Embodiment 44: The data storage system according to the preceding embodiment, wherein the small areas comprise small black areas.

Embodiment 45: The data storage system according to any one of the preceding embodiments referring to a data storage system, wherein the data storage system comprises a data carrier stack of at least two individual data carriers.

Embodiment 46: The data storage system according to the preceding embodiment, wherein the individual data carriers comprise different colors.

Embodiment 47: The data storage system according to the preceding embodiment, wherein the different colors of the individual data carriers are obtained by applying different organic fluorescent dyes to the matrix material of the data carrier.

Embodiment 48: A method for reading out data from a data carrier, the method comprising the following steps
a) providing at least one data carrier having data modules located at at least two different depths within the at least one data carrier;
b) providing a data readout device comprising:
   at least one illumination source for directing at least one light beam onto the data carrier;
   at least one detector adapted for detecting at least one modified light beam modified by at least one of the data modules, the detector having at least one optical sensor, wherein the optical sensor has at least one sensor region, wherein the optical sensor is designed to generate at least one sensor signal in a manner dependent on an illumination of the sensor region by the modified light beam, wherein the sensor signal, given the same total power of the illumination, is dependent on a beam cross-section of the modified light beam in the sensor region; and
c) evaluating the at least one sensor signal and deriving data stored in the at least one data carrier from the sensor signal.

Embodiment 49: The method according to the preceding embodiment, wherein the modified light beam is generated by reflecting the light beam by at least one of the data modules or by influencing the light beam transmitted through the data carrier by at least one of the data modules.

Embodiment 50: The method according to any one of the two preceding embodiments, wherein step c) comprises determining the depth of the data module from which the modified light beam originates, by evaluating the at least one sensor signal.

Embodiment 51: The method according to the preceding embodiment, wherein a beam cross-section of the modified light beam in the sensor region is determined by evaluating the sensor signal and by taking into account known beam properties of the light beam, thereby deriving the depth of the data module from which the modified light beam originates.

Embodiment 52: The method according to any one of the two preceding embodiments, wherein the at least one known correlation between the at least one sensor signal and the depth of the data module from which the modified light beam originates is used.

Embodiment 53: The method according to any one of the preceding method embodiments, wherein in step c) sensor signals provided by the optical sensor are classified according to the respective depths of the data modules.

Embodiment 54: The method according to any one of the preceding method embodiments, wherein at least two individual data carriers are arranged in a data carrier stack.

Embodiment 55: A use of an optical sensor for reading out data, the optical sensor having at least one sensor region, wherein the optical sensor is designed to generate at least one sensor signal in a manner dependent on an illumination of the sensor region by a light beam, wherein the sensor signal, given the same total power of the illumination, is dependent on a beam cross-section of the light beam in the sensor region.

Embodiment 56: The use according to the preceding embodiment, wherein the optical sensor is an organic photodetector, preferably an organic solar cell, more preferably a dye-sensitized organic solar cell and most preferably a solid dye-sensitized organic solar cell.

Embodiment 57: The use according to any one of the two preceding embodiments, wherein the optical sensor comprises at least one photosensitive layer setup, the photosensitive layer setup having at least one first electrode, at least one second electrode and at least one photovoltaic material sandwiched in between the first electrode and the second electrode, wherein the photovoltaic material comprises at least one organic material.

Embodiment 58: The use according to the preceding embodiment, wherein the photosensitive layer setup comprises an n-semiconducting metal oxide, preferably a nanoporous n-semiconducting metal oxide, wherein the photosensitive layer setup further comprises at least one solid p-semiconducting organic material deposited on top of the n-semiconducting metal oxide.

Embodiment 59: The use according to the preceding embodiment, wherein the n-semiconducting metal oxide is sensitized by using at least one dye.

Embodiment 60: The use according to any one of the three preceding embodiments, wherein at least one of the first electrode or the second electrode are fully or partially transparent.

### BRIEF DESCRIPTION OF THE FIGURES

Further optional details and features of the invention are evident from the description of preferred exemplary embodiments which follows in conjunction with the dependent claims. In this context, the particular features may be implemented alone or with several in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows a schematic setup of an embodiment of a data storage system including a data readout device and a data carrier;

FIG. 2 shows a schematic cross-sectional view of an embodiment of a detector and an evaluation device to be used in the data storage system of FIG. 1;

FIG. 3 shows an alternative embodiment of a data storage system including a data readout device and a data carrier;

FIG. 4 shows a schematic setup of an embodiment of a data storage system including a data readout device and a data carrier stack; and

FIG. 5 shows an alternative schematic setup of an embodiment of a data storage system including a data readout device and a data carrier stack.

### EXEMPLARY EMBODIMENTS

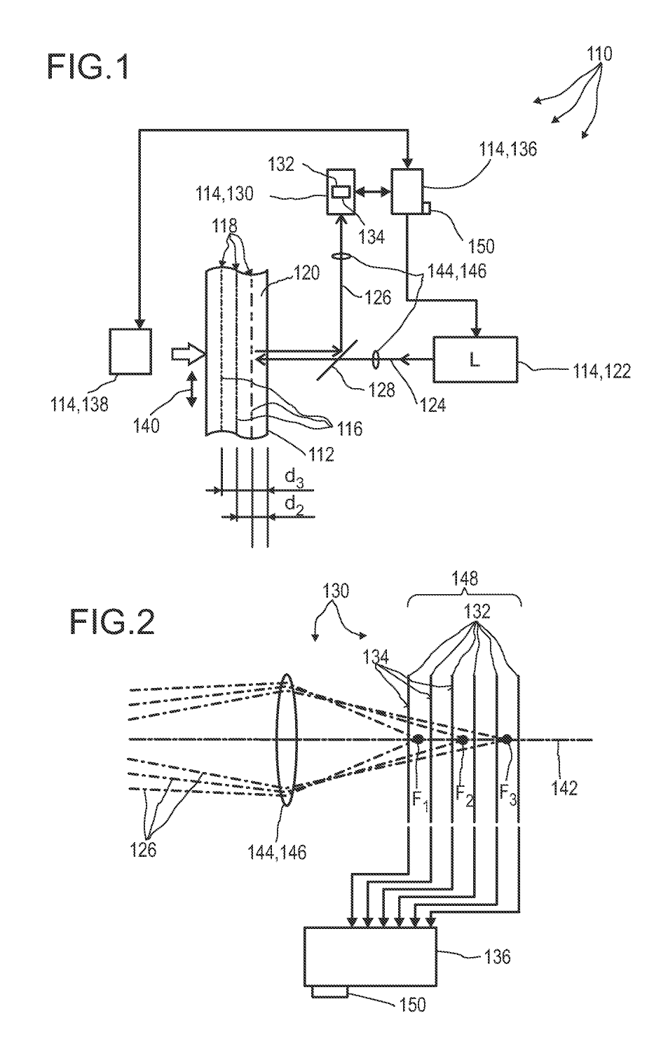

In FIG. 1, in a schematic view, an exemplary embodiment of a data storage system 110 is depicted. The data storage system 110, in this embodiment, includes a data carrier 112 and a data readout device 114, the latter of which having a plurality of components.

The data carrier 112 comprises a plurality of data modules 116 being, in this particular example, at least partially reflective data modules 116, which are symbolically depicted in FIG. 1. As an example, the data modules 116 may be arranged in information layers 118 which may be coated onto and/or embedded into a matrix material 120. As an example, the matrix material 120 may be or may comprise a transparent plastic material such as polycarbonate. The information layers 118 each, independently, may contain one or more thin metallic layers, such as aluminum layers, such as aluminum layers having a thickness in the range of 20 to 150 nm. For manufacturing of the information layers 118, reference may be made to technologies used in CD, DVD or Blu-ray technology. Thus, specifically, the layer setup of the data carrier 112 may correspond to a data carrier stack of CD, DVD or Blu-ray devices. The data modules 116 may be written by using known technologies, such as one or more of embossing, stamping, molding or writing by using optical technologies, such as laser writing. Specifically, known mastering technologies may be used. Therein, “mastering” generally refers to the process of creating a stamper or set of stampers to be used for molding, such as for injection molding. This technology is, as an example, known from CD manufacturing. Generally, for example, the data modules 116 and/or the surroundings may be created as pits and lands or grooves and lands. During the process of manufacturing, specifically during the process of mastering, a digital signal, such as a digital signal originating from a computer, may be used to guide a laser beam which etches a pattern, such as a pattern of pits and lands and/or a pattern of one or more continuous grooves onto a highly polished glass disc coated with photoresist. In addition, one or more of a curing step, a developing step and/or a rinsing step may be applied, in order to create a class master. Further, a metal mold, such as nickel and/or silver, may be electroformed on top. This mold may be removed and then electroplated with a metal, such as a nickel alloy, in order to create one or more stampers to be used in a subsequent molding process, such as in an injection molding machine, to press the data into the matrix material, such as into a polycarbonate substrate. This technology generally is known to the skilled person in the art of manufacturing of optical storage disks. Still, other technologies may be used such as direct writing.

The data readout device 114 as depicted in FIG. 1 further includes at least one illumination source 122. The illumination source 122, as an example, may be or may comprise at least one illumination source for generating collimated light, preferably coherent light, such as a laser L. As an example, wavelengths in the visible spectral range may be used, such as wavelengths as currently used for CD, DVD or Blu-ray technology, such as one or more of the wavelengths 780 nm, 650 nm or 405 nm. Thus, basically, the illumination source 122 as used in the present invention may correspond to commercially available illumination sources as used in CD, DVD or Blu-ray technology.

The illumination source 122 is adapted for generating at least one light beam 124 which is directed onto the data carrier 112, as symbolically depicted in FIG. 1. The light beam 124 is, at least partially, reflected by the data modules 116 of the information layers 118 which are arranged in different depths d₁, d₂ and d₃ within the data carrier 112. Thereby, one or more reflected light beams 126 are generated, which may be separated from the incident light beam 124 by one or more beam-splitting devices 128 and which may be directed towards at least one detector 130 of the data readout device 114.

The detector 130 comprises at least one optical sensor 132, as schematically depicted in FIG. 1. The optical sensor 132 has a sensor region 134 and is designed to generate at least one sensor signal in a manner dependent on an illumination of the sensor region 134 by the reflected light beam 126. The sensor signal, given the same total power of illumination, is dependent on a beam cross-section of the reflected light beam 126 in the sensor region 134. As outlined in further detail above, this effect generally is referred to as the FiP effect.

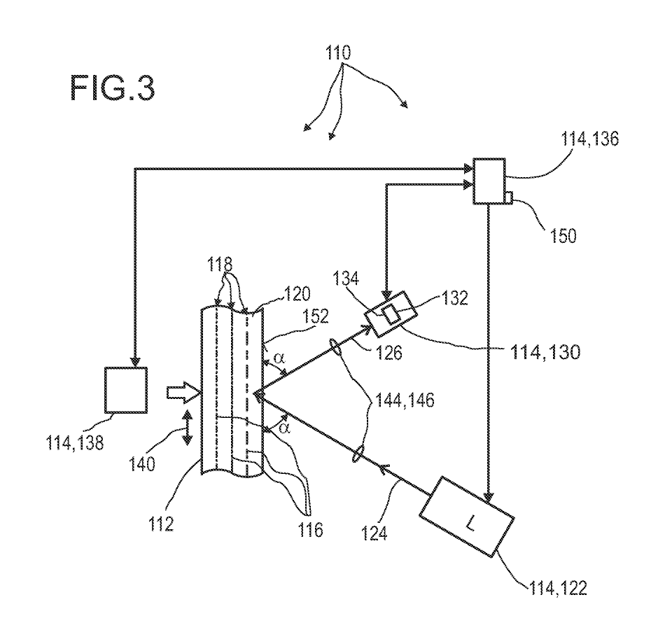

For potential setups of the optical sensor 132, reference may be made, as an example, to one or more of WO 2012/110924 A1 and WO 2014/097181. Thus, as an example, the layer setup of the at least one optical sensor 132 may correspond to one or more of the layer setups of the longitudinal optical sensors disclosed in WO 2014/097181. Additionally or alternatively, reference may be made to setup shown in FIGS. 2 and 3 of WO 2012/110924 A1, as well as to the corresponding description of these Figures in the specification. It shall be noted, however, that other layer setups are feasible. To increase the FiP effect, one or both of the light beam 124 or the reflected light beam 126 may be modulated, such as by modulating the illumination source 122 and/or by providing an additional modulation device as disclosed above.

As is evident from the different depths d₁, d₂ and d₃ of the information layers 118 within the data carrier 112, the optical path length of the light beams 124, 126, which is the total optical path length passed by these light beams 124, 126 between the illumination source 122 and the detector 130, varies dependent on the depth of the respective data module 116 by which the light beam 124 is reflected. Thus, light reflected by data modules 116 of the uppermost information layer having a depth d₁ travels over a distance 2 d₁ through the data carrier 112. Contrarily, light reflected by the deepest information layer 118 having a depth d₃ travels a distance 2 d₃ through the data carrier 112, which is increased by 2 (d₃−d₁) as compared to the uppermost information layer 118.

Due to the propagation properties of light beams 124, 126, however, the beam properties of the reflected light beam 126 are changed due to this additional optical path length. Thus, specifically, a beam waist of the reflected light beam 126, at the sensor region 134 of the optical sensor 124, changes due to this variation of the depth of the data modules 116. This variation in beam shape, specifically this variation in the beam cross-section of the reflected light beams 126, however, is detectable by the above-mentioned FiP effect. Thus, the at least one sensor signal generated by the at least one optical sensor 132 is dependent on the beam cross-section, and, thus, is dependent on the depth of the respective data modules 116 by which the light beam 124 is reflected. Consequently, by evaluating the at least one sensor signal, the depth of the respective data module 116 may be determined.

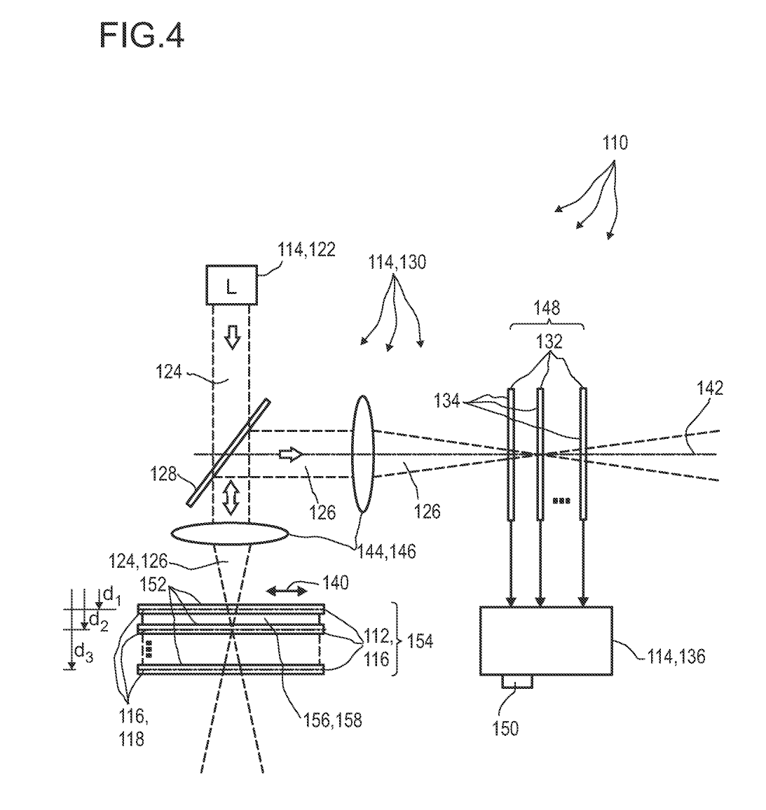

For evaluating the at least one sensor signal and for deriving data stored in the data carrier 112, the data readout device 114 comprises at least one evaluation device 136. The evaluation device 136, as an example, may be connected to the detector 130. The evaluation device 136 may further control the illumination source 122 and/or may control one or more actuators 138 which will be explained in further detail below. Thus, as an example, the evaluation device 136 may be adapted for evaluating the at least one sensor signal for detecting data modules 116. Further, for each detected data module 116, a depth of the data module 116 may be derived, such as by using a known correlation between the sensor signal and the depth. For examples of these correlations, reference may be made to the so-called FiP curves, as e.g. shown in one or more of the prior art documents mentioned above, such as in FIG. 4 of WO 2012/110924 A1.

The data modules 116 may be partially transparent such that light in various depths of the data carrier 112 may be detected spontaneously, without the need of refocusing the illumination source 122.

As outlined above, the data storage system 110 and, specifically, the data readout device 114 may further comprise additional components. Thus, as already mentioned, at least one actuator 138 may be present, for inducing at least one translational and/or rotational relative movement 140 of the data carrier 112 and the data readout device 114 or parts thereof. Thus, the data carrier 112 may be moved and/or the data readout device 114 or parts thereof may be moved in order to scan the data carrier 112 with the at least one light beam 124. Actuators 138 are generally known from CD, DVD or Blu-ray technology.

In FIG. 2, a cross-sectional view of a potential setup of the detector 130 is shown, in a plane parallel to an optical axis 142 of the detector 130.

Firstly, as symbolically depicted in FIG. 2, the detector 130 may comprise at least one transfer device 144 for directing and/or shaping the at least one reflected light beam 126. As an example, the transfer device 144 may comprise at least one lens or lens system 146.

In this regard, it shall be noted that the setup of the data readout device 114 and the data storage system 110 as e.g. depicted in FIG. 1, generally may comprise one or more transfer devices 144 such as one or more lenses 146 or lens systems. Thus, as an example and as depicted in FIG. 1, one or more lenses 146 may be provided in the beam path of light beam 124, such as for focusing the incident light beam 124 before illuminating the data carrier 112. Additionally or alternatively, one or more lenses 146 or lens systems may be provided in the beam path of the reflected light beam 126, wherein the one or more lenses 146 may fully or partially be part of the detector 130 and/or may fully or partially be embodied independent from the detector 130. Further, optionally, one or more additional optical elements may be provided, such as one or more reflective elements and/or one or more diaphragms, such as for beam-shaping or other optical purposes.

Symbolically depicted by the dotted, the dashed and the solid lines of the three exemplary reflected light beams 126, symbolically representing three different optical path lengths and, thus, symbolically depicting reflections from data modules 116 at different depths within the data carrier 112, focal points F₁, F₂ and F₃ are shifted in the direction of the optical axis 142 for these three different reflected light beams 126. Consequently, when measured at an arbitrary point along the optical axis 142, a beam cross-section of these light beams 126 changes, which may be detected by using the above-mentioned FiP effect and by evaluating sensor signals of these optical sensors 132 by using the evaluation device 136. Thus, by evaluating these sensor signals, in addition to the actual information value stored within each data module 116 read out by the data readout device 114, the depth of the respective data module 116 may be determined as an additional item of information.

As further depicted in the schematic setup of FIG. 2, optionally, one or more than one optical sensor 132 may be provided in the detector 130. Thus, as shown in FIG. 2, a sensor stack 148 of optical sensors 132 may be provided. The sensor signals of the optical sensors 132 of the sensor stack 148 may be evaluated. The use of a plurality of optical sensors 132, such as the use of the sensor stack 148, may be advantageous in many ways. Thus, as an example, ambiguities in the evaluation of the sensor signals may be resolved which generally may originate from the optical fact that a beam cross-section of a light beam, at a given distance before or after a focal point, is typically identical. Thus, by evaluating the sensor signals at more than one coordinate along the optical axis 142, these ambiguities may be resolved, as explained e.g. in WO 2014/097181. Thus, generally, by evaluating the sensor signals, beam parameters of the reflected light beams 126 may be generated. Further, the optical sensors 132 of the sensor stack 148 may have identical spectral properties or may provide differing spectral properties. Thus, as an example, the sensor stack 148 may comprise at least two different types of optical sensors 132 having differing spectral sensitivities, such as in an alternating arrangement. Thereby, colors of the reflected light beam 126 may be resolved. As an example, the illumination source 122 may be adapted for generating a plurality of light beams 124 having different colors, and the detector 130, in conjunction with the evaluation device 136, may be arranged for resolving these different colors.

The evaluation device 136, in one or more of the embodiments shown herein and/or in other embodiments of the present invention, may comprise one or more interfaces 150. As an example, the one or more interfaces 150 may be wire-bound and/or wireless interfaces. By using these one or more interfaces 150, data read out from the data carrier 112 may be provided to other devices. Thus, the data storage system 110 and/or the data readout device 114 may be implemented into a computer or a computer system or may be used as a stand-alone device.

In the setup of the data readout device 114 and the data storage system 110 as depicted in FIG. 1, the reflected light beam 126 may fully or partially propagate along the beam path of the incident light beam 124, before being separated off by the beam-splitting device 128. It shall be noted, however, that other setups of the beam paths are feasible. Thus, as an example, optical reflections from a front surface or a back surface of the data carrier 112 may be detrimental to the measurement. These reflections generally may occur in case the incident light beam 124 is oriented perpendicular to these surfaces. Further, generally, interference effects may occur, which generally may be due to the preferred collimated and coherent nature of the light beam 124.

Therefore and in order to avoid these and other detrimental optical effects, it may be preferable to use and optical setup in which incident light beam 124 hits the surface of the data carrier 112 at an angle other than 90°, i.e. in an oblique fashion. Further, it may be preferable to avoid a setup in which the reflected light beam 126 propagates along the beam path of the incident light beam 124.

An exemplary setup of this kind is shown in FIG. 3. Therein, a data storage system 110, a data carrier 112 and a data readout device 114 are shown which generally correspond to the exemplary embodiment shown in FIG. 1. Thus, for most details of the setup, reference may be made to FIG. 1 and the description of FIG. 1 given above.

In the setup of FIG. 3, the incident light beam 124 hits a front surface 152 of the data carrier 112 at an angle a between 0° and 90°, such as at an angle between 10° and 85° or between 30° and 75°. Thereby, the above-mentioned interference effects between incident light beam 124 and reflected light beam 126 may be avoided. Further, unwanted internal reflections within the data carrier 112 and interference effects induced thereby may be suppressed. Further, the use of a beam-splitting device 128 may be avoided in the setup, even though the use of one or more beam-splitting devices is still possible.

FIG. 4 shows, in a schematic view, an exemplary embodiment of a further data storage system 110. In this particular embodiment, the data storage system 110 comprises a data readout device 114 and a plurality of data carriers 112 which are arranged in form of a data carrier stack 154. Herein, each of the plurality of the data carriers 112 comprises at least one of the at least partially reflective data modules 116 within the information layers 118. Exemplary, three individual data carriers 112 each comprising a single data module 116 are symbolically depicted in FIG. 4. Herein, each of the plurality of the data carriers 112 may comprise one of a DVD, a CD or a Blu-ray device.

Especially for providing an optimized optical path for the light beam 124 which traverses the data carrier stack 154, a thin film 156 of an optically transparent adhesive 158 is applied in this particular embodiment between two adjacent the data carriers 112 within the data carrier stack 154. Herein, the adhesive 158 preferably exhibits a refraction index which may be equal or similar to the refraction index of the matrix material 120 as used in the data carriers 112 being placed in an adjacent manner with respect to the thin film 156. In particular by carefully selecting the corresponding refraction indices, the incident beam 124 can, thus, traverse the data carrier stack 154 with only a negligible refraction.

The illumination source 122 is adapted for generating at least one light beam 124 which is directed onto the plurality of the data carriers 112 within the data carrier stack 154, as symbolically depicted in FIG. 1. Herein, the light beam 124 is, at least partially, reflected by the data modules 116 of the information layers 118 which are arranged in different data carriers 112 which, due to their spatial extent, are located at three different longitudinal positions, i.e. at the depths d₁, d₂ and d₃.

The hereby generated reflected light beams 126 may be separated from the incident light beam 124 by one or more beam-splitting devices 128 and directed towards the at least one detector 130 of the data readout device 114. As symbolically depicted in FIG. 4, the detector 130 may comprise at least one transfer device 144 for directing and/or shaping the at least one reflected light beam 126. As an example, the transfer device 144 may comprise at least one lens or lens system 146.

In this example, the detector 130 comprises a sensor stack 148 of optical sensors 132, wherein the sensor signals of the optical sensors 132 of the sensor stack 148 may be evaluated by the evaluation device 136. As described above, each of the optical sensors 132 in the sensor stack 148 has a sensor region 134 and is designed to generate at least one sensor signal in a manner dependent on an illumination of the sensor region 134 by the reflected light beam 126. The sensor signal, given the same total power of illumination, is dependent on a beam cross-section of the reflected light beam 126 in the sensor region 134. According to this FiP effect, the sensor signal of each optical sensor 132, which may, preferably comprise a photocurrent i, is dependent on the photon flux F, given the same total power P of illumination. Consequently, each optical sensor 132 in the sensor stack 148 may, therefore, selectively detect the photon flux of each of the data carriers 112 in the data carrier stack 154. As a result, it may, thus, be possible to acquire information form each of the data carriers 112 with the data carrier stack 154 simultaneously.

Specifically, in this embodiment or other embodiments of the present invention, the data modules 116 within at least one of the data carriers 112 may be partially transparent, such that a first part of the incident light of the light beam 124 may be transmitted by the data modules 116 and a second part of the incident light beam 124 may be reflected by the data modules 116. In a particular embodiment, the matrix material 120 as comprised by the transparent data carrier 112 differs for at least two of the data carriers 112, preferably for all of the data carriers 112, within the data carrier stack 154. In a preferred example, this distinction is achieved by choosing the matrix material 120 for the respective data carriers 112 in a manner that it is different for each data carrier 112 by one or more properties of the matrix material 120. As a particularly preferred example, the transparent data carriers 112 comprise a different organic fluorescent dye used for dying the respective matrix material 120. As a result, the different colors of the colored data carriers 112 may, thus, be used to distinguish between the data carriers 112.

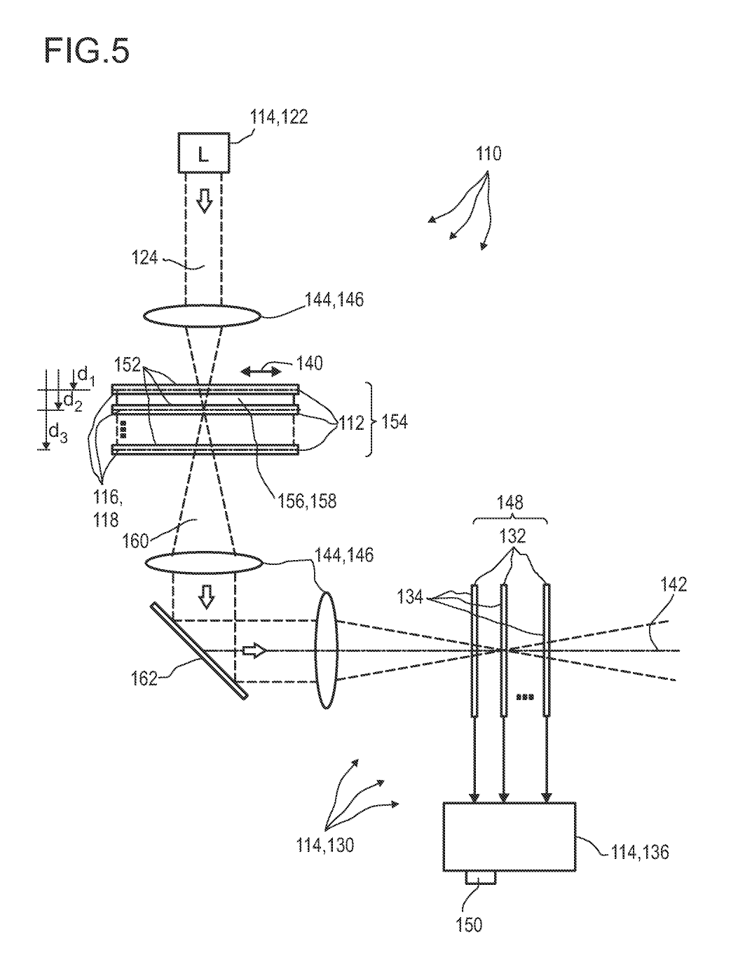

A further embodiment is schematically depicted in FIG. 5, in which, alternatively to employing the generated reflected light beams 126, one or more of the transmitted lights beams 160 may be guided to the detector 130, preferably by using a suitably placed mirror 162, via the transfer device 144, such as the lens 146, to the sensor stack 148 of the optical sensors 132. For this purpose, the data carriers 112 may comprise data modules 116 which are adapted of modifying a transmission of the light beam 124 through the data carrier stack 154, irrespective of a fact whether they might exhibit reflective properties or not. In particular, the data modules may appear as an arrangement as black points located within the information layer 118 which may be capable of disturbing the light beam 124 focused to the information layer 118 in a manner that the transmission of the light beam 124 through the data carrier stack 154 may be modified.

Furthermore, the embodiment as schematically shown in FIG. 4, in which the reflected light beams 126 are guided to the detector 130, may also be combined with the embodiment of FIG. 5, in which the transmitted lights beams 156 are guided to the detector 130. For further details concerning the embodiment as schematically depicted in FIG. 5 reference may be made to the embodiment of FIG. 4.

### LIST OF REFERENCE NUMBERS

110 data storage system
112 data carrier
114 data readout device
116 data modules
118 information layer
120 matrix material
122 illumination source
124 light beam
126 reflected light beam
128 beam-splitting device
130 detector
132 optical sensor
134 sensor region
136 evaluation device
138 actuator
140 translational and/or rotational relative movement
142 optical axis
144 transfer device
146 lens
148 sensor stack
150 interface
152 front surface
154 data carrier stack
156 thin film
158 transparent adhesive layer
160 transmitted light beam
162 mirror

1. A data readout device for reading out data from at least one data carrier having data modules located at at least two different depths within the at least one data carrier, the data readout device comprising:
at least one illumination source for directing at least one light beam onto the data carrier;
at least one detector adapted for detecting at least one modified light beam modified by at least one of the data modules, the detector having at least one optical sensor, wherein the optical sensor has at least one sensor region, wherein the optical sensor is designed to generate at least one sensor signal in a manner dependent on an illumination of the sensor region by the modified light beam, wherein the sensor signal, given the same total power of the illumination, is dependent on a beam cross-section of the modified light beam in the sensor region; and
at least one evaluation device adapted for evaluating the at least one sensor signal and for deriving data stored in the at least one data carrier from the sensor signal.

2. The data readout device according to claim 1, wherein the data modules are reflective data modules, wherein the light beam directed onto the data carrier is modified by being reflected by at least one of the reflective data modules.

3. The data readout device according to claim 1, wherein a transmitted light beam is generated by at least one of the data modules being capable of modifying the light beam directed onto the data carrier, wherein a transfer device focuses the light beam onto one of the depths where the data modules are located.

4. The data readout device according to claim 3, wherein the detector further comprises at least one further transfer device adapted for transferring the modified light beam to the at least one optical sensor.

5. The data readout device according to claim 1, wherein the evaluation device is adapted to determine the depth of the data module from which the modified light beam originates, by evaluating the at least one sensor signal.

6. The data readout device according to claim 5, wherein the evaluation device is adapted to use at least one known correlation between the at least one sensor signal and the depth of the data module from which the modified light beam originates.

7. The data readout device according to claim 1, wherein the optical sensor is an organic photodetector.

8. The data readout device according to claim 1, wherein the optical sensor comprises at least one photosensitive layer setup, the photosensitive layer setup having at least one first electrode, at least one second electrode and at least one photovoltaic material sandwiched in between the first electrode and the second electrode, wherein the photovoltaic material comprises at least one organic material.

9. The data readout device according to claim 1, wherein the detector comprises a sensor stack of at least two optical sensors.

10. The data readout device according to the claim 9, wherein at least one optical sensor of the sensor stack is at least partially transparent.

11. The data readout device according to claim 9, wherein the evaluation device is adapted to evaluate at least the sensor signals generated by at least two of the optical sensors of the sensor stack.

12. The data readout device according to claim 11, wherein the evaluation device is adapted to derive at least one beam parameter from the at least two sensor signals generated by the at least two optical sensors of the sensor stack.

13. The data readout device according to claim 1, wherein the illumination source is adapted to generate at least two different light beams having different colors.

14. The data readout device according to claim 13, wherein the detector is adapted for distinguishing reflected light beams having different colors.

15. The data readout device according to claim 14, wherein the detector comprises at least two optical sensors having differing spectral sensitivities.

16. A data storage system, comprising:
at least one data readout device according to claim 1,
the data storage system further comprising at least one data carrier having data modules located at at least two different depths within the at least one data carrier.

17. The data storage system according to claim 16, wherein the data carrier comprises a layer setup, the layer setup having at least two different information layers, wherein the data modules are located in the at least two different information layers.

18. The data storage system according to claim 16, wherein the data storage system comprises a data carrier stack of at least two data carriers.

19. A method for reading out data from at least one data carrier, the method comprising:
a) providing at least one data carrier having data modules located at at least two different depths within the at least one data carrier;
b) providing a data readout device comprising:
at least one illumination source for directing at least one light beam onto the data carrier;
at least one detector adapted for detecting at least one modified light beam modified by at least one of the data modules, the detector having at least one optical sensor, wherein the optical sensor has at least one sensor region, wherein the optical sensor is designed to generate at least one sensor signal in a manner dependent on an illumination of the sensor region by the modified light beam, wherein the sensor signal, given the same total power of the illumination, is dependent on a beam cross-section of the reflected light beam in the sensor region; and
c) evaluating the at least one sensor signal and deriving data stored in the at least one data carrier from the sensor signal.

20. (canceled)
